(19) United States
(12) Patent Application Publication
(10) Pub. No.: US 2007/0181742 A1
(43) Pub. Date: Aug. 9, 2007

(54) FLYING OBJECT WITH TANDEM ROTORS

(75) Inventors: Alexander Jozef Magdalena Van de Rostyne, Bornem (BE); Kei Fung Choi, Causeway Bay (HK)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: SILVERLIT TOYS MANUFACTORY, LTD., Causeway Bay (HK)

(21) Appl. No.: 11/736,506

(22) Filed: Apr. 17, 2007

Related U.S. Application Data
(63) Continuation-in-part of application No. 11/462,177, filed on Aug. 3, 2006.
(63) Continuation-in-part of application No. 11/465,781, filed on Aug. 18, 2006.

(30) Foreign Application Priority Data
Jan. 19, 2006 (BE) 2006/0043

(51) Int. Cl. B64C 27/08

(52) U.S. Cl. 244/17.23

(57) ABSTRACT

A flying object with tandem rotors, in particular a helicopter, has a main rotor and a tandem rotor each with propeller blades which are driven by a rotor shaft and which is hinge-mounted to this rotor shaft. The angle between the surface of rotation of the main rotor and the rotor shaft may vary. A swinging manner on an oscillatory shaft is essentially transverse to the rotor shaft of the main rotor and is directed transversally to the longitudinal axis of the vanes. The main rotor and the tandem rotor each have an auxiliary rotor connected respectively to the main rotor and tandem rotor by a mechanical link. The swinging motions of the auxiliary rotor controls the angle of incidence (A) of at least one of the propeller blades of the main rotor and tandem rotor. There is an acute angle of displacement when viewing the propeller blades relative to the vanes in a direction perpendicular to their respective rotational planes.

### RELATED APPLICATIONS

This application is a Continuation-in-Part of U.S. Utility patent application Ser. No. 11/462,177 filed on Aug. 3, 2006 and U.S. Utility patent application Ser. No. 11/465,781 filed on Aug. 18, 2006, both of which claim priority to Belgian Patent Application No. 2006/0043 filed on Jan. 19, 2006. The contents of these applications are incorporated by reference herein.

### BACKGROUND

The present disclosure concerns an improved flying object with tandem rotors, in particular a helicopter.

The disclosure concerns a helicopter generally. In particular, but not exclusively, it is related to a toy helicopter and in particular to a remote-controlled model helicopter or a toy helicopter.

A helicopter is a complex machine, which is generally unstable and as a result difficult to control. Significant experience is required to safely operate helicopters without mishaps.

Typically, a helicopter includes a body, a main rotor and a tail rotor. In other cases a helicopter includes a body, a main rotor and a second tandem rotor. The disclosure is concerned primarily with a helicopter having a main rotor and a tandem rotor.

Tandem helicopters have two rotors of more or less similar diameter. The rotors are disposed along the helicopter body typically towards each end. The tips of the rotor paths may overlap to a certain extend. In that case one rotor is positioned higher than the other to avoid collision of the rotor blades.

It has been shown that the counter rotation of rotors on a tandem configuration, where the rotor axes are at a certain distance from each other, have destabilizing and asymmetrical effects. Yaw changes induce fore/aft drift, and the rotors push the tandem to lean over and slip. Different lift forces are required for example to move the helicopter forward or backward, and thereby different torques between the two rotors create undesired yaw effects. The combination of all these effects makes it hard to find a natural trim of the tandem for stable hover without pilot correction on the fore/aft and sideways dimension.

The main rotor and tandem rotor provide an upward force to keep the helicopter in the air, as well as a lateral or forward or backward force to steer the helicopter in required directions. This can be achieved by making the angle of incidence of the propeller blades of the rotors vary cyclically with revolutions of the rotors.

The rotors have a natural tendency to deviate from its position, which may lead to uncontrolled movements and to a crash of the helicopter if the pilot loses control over the steering of the helicopter.

Solutions make use of the known phenomenon of gyroscopic precession caused by the Coreolis force and the centrifugal forces to obtain the desired effect.

In general, the stability of a tandem helicopter includes the result of the interaction between:

the rotation of the rotor blades; the movements of any possible stabilizing rods;

the system, such as a gyroscope or the like, to compensate for small undesired variations in the resistance torque of the rotors; and

control of the helicopter, which controls the rotors.

When these elements are essentially in balance, the pilot should be able to steer the helicopter as desired.

This does not mean, however, that the helicopter can fly by itself or on auto pilot and can thus maintain a certain flight position or maneuver, for example, hovering or making slow movements without the intervention of a pilot.

Moreover, flying a helicopter usually requires intensive training and much experience of the pilot, for both a full size operational real helicopter as well as a toy helicopter or a remote-controlled model helicopter.

### SUMMARY

The present disclosure aims to minimize one or several of the above-mentioned and other disadvantages by providing a simple and cheap solution to auto stabilize a flying object with tandem rotors, in particular a helicopter. Operating the helicopter becomes simpler and possibly reduces the need for long-standing experience of the pilot.

The flying object with tandem rotors, in particular a helicopter, should meet the following requirements to a greater or lesser degree:

(a) it can return to a stable hovering position, in case of an unwanted disturbance of the flight conditions. Such disturbance may occur in the form of a gust of wind, turbulences, a mechanical load change of the body or the rotors, a change of position of the body as a result of an adjustment to the cyclic variation of the pitch or angle of incidence of the propeller blades of the rotors; and

(b) the time required to return to the stable position should be relatively short and the movement of the helicopter should be relatively small.

The disclosure concerns a flying object with tandem rotors, in particular a helicopter, including a body with a main rotor with propeller blades which are driven by a rotor shaft and which are mounted to the rotor shaft by a joint. The angle between the surface of rotation of the main rotor and the rotor shaft may vary. There is also a tandem rotor which has propeller blades which are driven by a rotor shaft and which are mounted to the rotor shaft by a joint. The angle between the surface of rotation of the tandem rotor and the rotor shaft may vary.

The helicopter includes the autostable rotors as described in U.S. patent application Ser. No. 11/462,177, filed on Aug. 3, 2006 and entitled HELICOPTER, and No. 11/465,1781, filed on Aug. 18, 2006 entitled HELICOPTER.

In one form of the disclosure, the helicopter has both the main rotor and the tandem rotors spinning in the same direction. In another form of the disclosure, the helicopter has the main rotor and the tandem rotors spinning in opposite directions.

When an external yaw disturbance causes the body to rotate, then both rotors see the same amount of decrease or increase in rotation speed for rotors rotating in the same direction. When the rotors are counter-rotating, the amount is similar but the changes are opposite. This is about equal to the rotation speed of the body.

The two rotors, namely the main rotor and the tandem rotor, are located at a certain horizontal distance one from another. Those rotors are inclined in the case of same direction turning rotor, such that they essentially compensate for the torque effects induced by the spinning rotors.

The effects of yaw, pilot induced or uninitiated/unwanted, essentially overcomes drift in the for/after dimension, and undesired inclination of the body. The spiral thrust essentially does not incline or cause sideways drift the body when rotors turn in same direction.

In one form of the disclosure, the helicopter main and tandem rotors are each provided with an auxiliary rotor which is driven by the shaft of the respective main rotor or tandem rotor. The auxiliary rotor is provided with two vanes extending essentially in line or at an acute angle relative with their longitudinal axes. This acute angle of displacement is determined when viewing the propeller blades relative to the vanes in a direction perpendicular to their respective rotational planes.

In some other forms of the disclosure, there may be an auxiliary rotor on only one of the main rotor or the tandem rotor.

The ‘longitudinal’ axis is seen in the plane of rotation of the main rotor, and is essentially parallel to the longitudinal axis of at least one of the propeller blades of the main rotor or is located at a relatively small acute angle with the latter propeller blade axis. As such each vane of the auxiliary rotor is relatively offset from the respective propeller of the main rotor when viewed perpendicular to the plane of rotation of the main rotor and the auxiliary rotor.

This auxiliary rotor is provided in a swinging manner on an oscillatory shaft which is provided essentially transversal to the rotor shaft of the main and tandem rotor respectively. This is directed essentially transverse to the longitudinal axis of the vanes.

The main rotor and the auxiliary rotor are connected to each other through a mechanical link, such that the swinging motions of the auxiliary rotor control the angle of incidence of at least one of the propeller blades of the main rotor. The tandem rotor and the auxiliary rotor are connected to each other through a mechanical link, such that the swinging motions of the auxiliary rotor control the angle of incidence of at least one of the propeller blades of the main rotor.

In some cases, the yaw control of the tandem helicopter is enhanced by extending the body forwardly and/or rearwardly by using a fin extension and/or extending the body itself in at least one of those directions. Having both the front and the rear extended is an effective yaw control.

In practice, it appears that such an improved tandem helicopter is more stable and stabilizes itself relatively quickly with or without a restricted intervention of the user.

The main rotor with propeller blades is driven by a rotor shaft on which the blades are mounted. The auxiliary rotor is driven by the rotor shaft of the main rotor and is provided with vanes from the rotor shaft in the sense of rotation of the main rotor.

The auxiliary rotor is mounted in a swinging relationship on an oscillatory shaft and the swinging motion being relatively upwardly and downwardly about the auxiliary shaft. The auxiliary shaft is provided essentially transverse to the rotor shaft of the main rotor. The main rotor and the auxiliary rotor are connected to each other by a mechanical link, such that the swinging motion of the auxiliary rotor controls the angle of incidence of at least one of the propeller blades of the main rotor.

The angle of incidence of the rotor in the plane of rotation of the rotor and the rotor shaft may vary; and an auxiliary rotor rotatable with the rotor shaft is for relative oscillating movement about the rotor shaft. Different relative positions are such that the auxiliary rotor causes the angle of incidence the main rotor to be different. A linkage between the main and auxiliary rotor causes changes in the position of the auxiliary rotor to translate to changes in the angle of incidence.

The propeller blades of the main rotor and the vanes of the auxiliary rotor respectively are connected to each other with a mechanical linkage that permits the relative movement between the blades of the propeller and the vanes of the auxiliary rotor.

### DRAWINGS

In order to further explain the characteristics of the disclosure, the following embodiments of an improved helicopter according to the disclosure are given as an example only, without being limitative in any way, with reference to the accompanying drawings, in which:

FIG. 1 represents a perspective view of an embodiment of the helicopter with the rotors turning in the same direction;

FIG. 2 represents a top view of the embodiment of the helicopter with the rotors turning in the same direction;

FIG. 3 represents a bottom view of the embodiment of the helicopter with the rotors turning in the same direction;

FIG. 4 represents a front view of the embodiment of the helicopter with the rotors turning in the same direction;

FIG. 5 is a rear view of the embodiment of the helicopter with the rotors turning in the same direction;

FIG. 6 is a right view of the embodiment of the helicopter with the rotors turning in the same direction;

FIG. 7 is a left view of the embodiment of the helicopter with the rotors turning in the same direction;

FIG. 8 is a sectional side view of the embodiment of the helicopter with the rotors turning in the same direction;

FIG. 9 is a sectional front view through the front rotor structure of the helicopter with the rotors turning in the same direction.

FIG. 10 represents another configuration of a tandem helicopter as viewed from the side with the rotors turning opposite to each other;

FIG. 11 represents another configuration of a tandem helicopter as viewed from the top with the rotors turning opposite to each other;

FIG. 12 represents a typical diagrammatic configuration of a tandem helicopter as viewed from the top with the rotors turning opposite to each other;

FIG. 13 represents a typical diagrammatic configuration of a tandem helicopter as viewed from the side with the rotors turning opposite to each other with the stabilizer removed for clarity;

FIG. 14 represents a typical diagrammatic configuration of a tandem helicopter as viewed from the top with the rotors turning in the opposite direction, with the stabilizer omitted for clarity;

FIG. 15 represents a typical diagrammatic configuration of a tandem helicopter as viewed from the front with the rotors turning in the opposite direction, with the stabilizer omitted for clarity;

FIG. 16 represents a typical diagrammatic configuration of a tandem helicopter as viewed from the top with the rotors turning in the same direction;

FIG. 17 represents a typical diagrammatic configuration of a tandem helicopter as viewed from the front with the rotors turning in the same direction, with the stabilizer omitted for clarity;

FIG. 18 represents another configuration of a tandem helicopter as viewed from the side;

FIG. 19 represents another configuration of a tandem helicopter as viewed from the side, with the stabilizer omitted for clarity with the rotors turning in the same direction;

FIG. 20 represents a configuration of a tandem helicopter of FIG. 19 as viewed from the top, with the stabilizer omitted for clarity with the rotors turning in the same direction;

FIG. 21 represents a configuration of a tandem helicopter of FIG. 19 as viewed from the top, with the stabilizer omitted for clarity with the rotors turning in the same direction;

FIG. 22 represents another configuration of a tandem helicopter as viewed from the side, with the stabilizer omitted for clarity with the rotors turning in the same direction;

FIG. 23 represents another configuration of a tandem helicopter as viewed from a perspective side position, with the rotors and stabilizer omitted for clarity with the rotors turning in the same direction;

FIG. 24A represents the configuration of a tandem helicopter of FIG. 23 as viewed from the front, with the rotors and stabilizer omitted for clarity with the rotors turning in the same direction;

FIG. 24B represents the configuration of a tandem helicopter of FIG. 23 as viewed from the rear, with the rotors and stabilizer omitted for clarity with the rotors turning in the same direction;

FIG. 25 represents yet another configuration of a tandem helicopter as viewed in perspective with the rotors and stabilizer omitted for clarity with the rotors turning in the same direction;

FIG. 26 represents the system for controlling yaw in a tandem helicopter with the rotors turning in the same direction;

FIG. 27 represents a detail of the main rotor and auxiliary rotor;

FIG. 28 is a further representation of the main rotor and auxiliary rotor;

FIG. 29 is a further detailed representation of the main rotor and auxiliary rotor and linkages between them; and

FIG. 30 is a further detailed representation of the main rotor and auxiliary rotor.

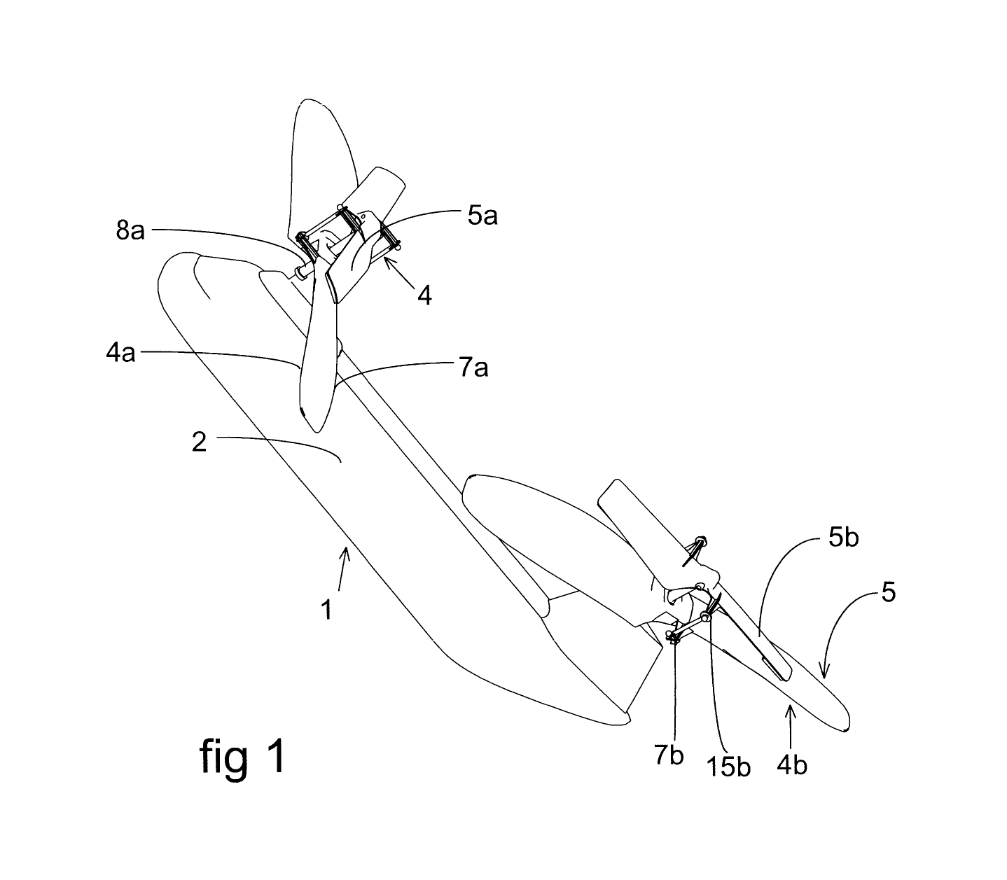

### DETAILED DESCRIPTION

A helicopter comprises a body, a main rotor with propeller blades which is driven by a rotor shaft on which the blades are mounted. There is a tandem rotor driven by a second rotor shaft. In some cases the rotor shafts are directed substantially parallel to the rotor shaft of the main rotor. In other cases, the rotor shafts can be inclined relative to each other. One shaft can incline to the left, and the other shaft can incline to the right as viewed from the front or the rear of the helicopter or vice versa.

An auxiliary rotor is driven by the rotor shaft of the main rotor and is provided with vanes from the rotor shaft for rotation in the sense of rotation of the main rotor. The auxiliary rotor is mounted in a swinging relationship on an oscillatory shaft and the swinging motion is relatively upwardly and downwardly about the auxiliary shaft.

The diameter of the auxiliary rotor is smaller than the diameter of the main rotor. The main rotor and the tandem rotor rotate in the same direction.

The auxiliary shaft for the main rotor is provided essentially transverse to the rotor shaft of the main rotor. The main rotor and the auxiliary rotor are connected to each other by a mechanical link, such that the swinging motion of the auxiliary rotor controls the angle of incidence of at least one of the propeller blades of the main rotor.

There is also an auxiliary rotor driven by the rotor shaft of the tandem rotor. There are vanes from the tandem rotor shaft for rotation in the sense of rotation of the tandem rotor. The auxiliary rotor is mounted in a swinging relationship on an oscillatory shaft and the swinging motion being relatively upwardly and downwardly about the auxiliary shaft. There are configurations where only one of the two rotor is equipped with an auxiliary rotor.

The auxiliary shaft for the tandem rotor is provided essentially transverse to the rotor shaft of the tandem rotor. The tandem rotor and the auxiliary rotor are connected to each other by a mechanical link, such that the swinging motion of the auxiliary rotor controls the angle of incidence of at least one of the propeller blades of the tandem rotor

The main rotor and tandem rotor each includes two propeller blades situated essentially in line with each other in some cases. In other cases, the rotor shafts are inclined relative to each other.

The propeller blades of the main rotor, and the vanes of the auxiliary rotor are connected to the main rotor with a mechanical linkage that permits the relative movement between the blades of the main propeller and the vanes of the auxiliary rotor. There is a joint of the main rotor to the propeller blades formed of a spindle, which is fixed to the rotor shaft of the main rotor.

The propeller blades of the tandem rotor, and the vanes of the auxiliary rotor for the tandem rotor are connected to the tandem rotor with a mechanical linkage that permits the relative movement between the blades of the tandem propeller and the vanes of the auxiliary rotor. There is a joint of the tandem rotor to the propeller blades formed of a spindle, which is fixed to the rotor shaft of the tandem rotor.

The spindle of the main rotor and tandem rotors extend essentially in the longitudinal direction of the propeller blade of the main rotor and tandem rotors respectively. This is parallel to one of the vanes or is located at an acute angle relative to the longitudinal direction.

The mechanical link includes a rod hinge mounted to a vane of the auxiliary rotor with one fastening point and is hinge-mounted with another fastening point to the propeller blade of the main rotor. The fastening point of the rod is situated on the main rotor at a distance from the axis of the spindle of the propeller blades of the main rotor, and the other fastening point of the rod is situated on the auxiliary rotor at a distance from the axis of the oscillatory shaft of the auxiliary rotor. The rod is fixed to lever arms with its fastening point respectively part of the main rotor and of the auxiliary rotor A similar construction applies between the propeller blade of the tandem rotor and the vanes of the auxiliary rotor of the tandem rotor

The distance between the fastening point of the rod on the main rotor and the axis of the spindle of the propeller blades of the main rotor is larger than the distance between the fastening point of the rod on the auxiliary rotor and the axis of the oscillatory shaft of the auxiliary rotor. A similar construction and configuration applies for the propeller blade of the tandem rotor and the vanes of the auxiliary rotor of the tandem rotor

The longitudinal axis of the vanes of the auxiliary rotor in the plane of rotation is located at an acute angle relative to each other. This angle can be about 10° to about 17° with the longitudinal axis of one of the propeller blades of the main rotor. In another form, the longitudinal axis of one of the propeller blades of the main rotor in the plane of rotation, is located at an acute angle with the axis of a spindle mounting these propeller blades to the rotor shaft.

The ‘longitudinal’ axis is seen in the plane of rotation of the main rotor, and is essentially parallel to the longitudinal axis of at least one of the propeller blades of the main rotor or is located at a relatively small acute angle with the latter propeller blade axis. Each vane of the auxiliary rotor is relatively offset from the respective propeller of the main rotor that is closest to it.

When viewed perpendicular to the plane of rotation of the main rotor and the auxiliary rotor this offset is a small acute angle. In some case each vane and its respective closest or related propeller are aligned and not offset. The vanes can be of any size and shape. The vanes can have a shape as a blade. In some situations there can be a rod which is at a relatively small angle, for instance about 17 degrees relative to the propeller. The blades of the vanes can have any suitable profile as viewed from an end, a cross-section laterally through the vane or longitudinally through the vane or longitudinally from a side. In some cases the rods are cylindrical elements and may have weights disposed at different points on the rods.

In a different manner, there is provided a helicopter having a body; and a main rotor with propeller blades which is driven by a rotor shaft and which is mounted on this rotor shaft. The system permits the angle of incidence of the main rotor in the plane of rotation of the rotor and the rotor shaft to vary. An auxiliary rotor is rotatable with the rotor shaft and is for relative oscillating movement about the rotor shaft. Different relative positions are established so that the auxiliary rotor causes the angle of incidence the main rotor to be different.

In yet a different manner, a helicopter has a body; and a main rotor with propeller blades which is driven by a rotor shaft and which is mounted on this rotor shaft. The angle between the plane of rotation of the main rotor and the rotor shaft may vary. An auxiliary rotor is driven by the rotor shaft of the main rotor and is provided with two vanes. The main rotor and the auxiliary rotor are connected to each other by a mechanical link, such that the motion of the auxiliary rotor controls the angle of incidence of at least one of the propeller blades of the main rotor. There is a tandem rotor which is driven by a second rotor shaft which is directed substantially parallel to the rotor shaft of the main rotor.

The helicopter can be such the main rotor and the tandem rotor rotate in the same direction. Alternatively the main rotor and the tandem rotor rotate in the opposite.

The helicopter 1 represented in the figures generally by way of example is a remote-controlled helicopter which essentially includes a body 2 which can include some form of a landing gear. There is a first system 4 being a main rotor 4a; an auxiliary rotor 5a driven synchronously, and also a second system 5 being a tandem rotor 4b; an auxiliary rotor 5b driven synchronously. The auxiliary rotors 5a and 5b and related controls, being the drive and/or control rods from respectively two stabilizers for the helicopter.

The main rotor 4a is provided by a rotor head 7a on a first upward directed rotor shaft 8a which is bearing-mounted in the body 2 of the helicopter 1 in a rotating manner. This is driven by a motor 9a and a transmission 10a, including gearing. The motor 9a is for example an electric motor which is powered by an electric microprocessor and battery 11. The tandem rotor system is similarly constructed, namely there is a motor 9b and a transmission 10b, whereby the motor 9b is for example an electric motor which is powered by a battery 11.

The main rotor 4a in this case has two propeller blades 12a which are in line or practically in line, but which may just as well be composed of a larger number of propeller blades 12a. The tandem rotor 4b in this case has two propeller blades 12b which are in line or practically in line, but which may just as well be composed of a larger number of propeller blades 12b.

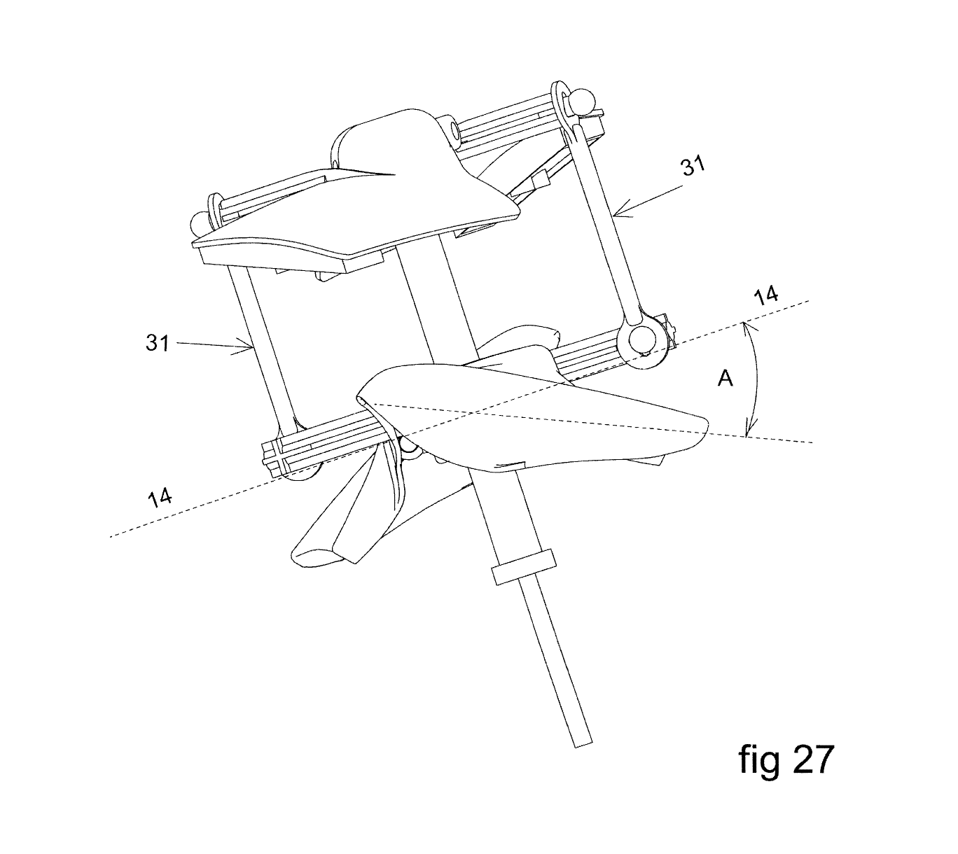

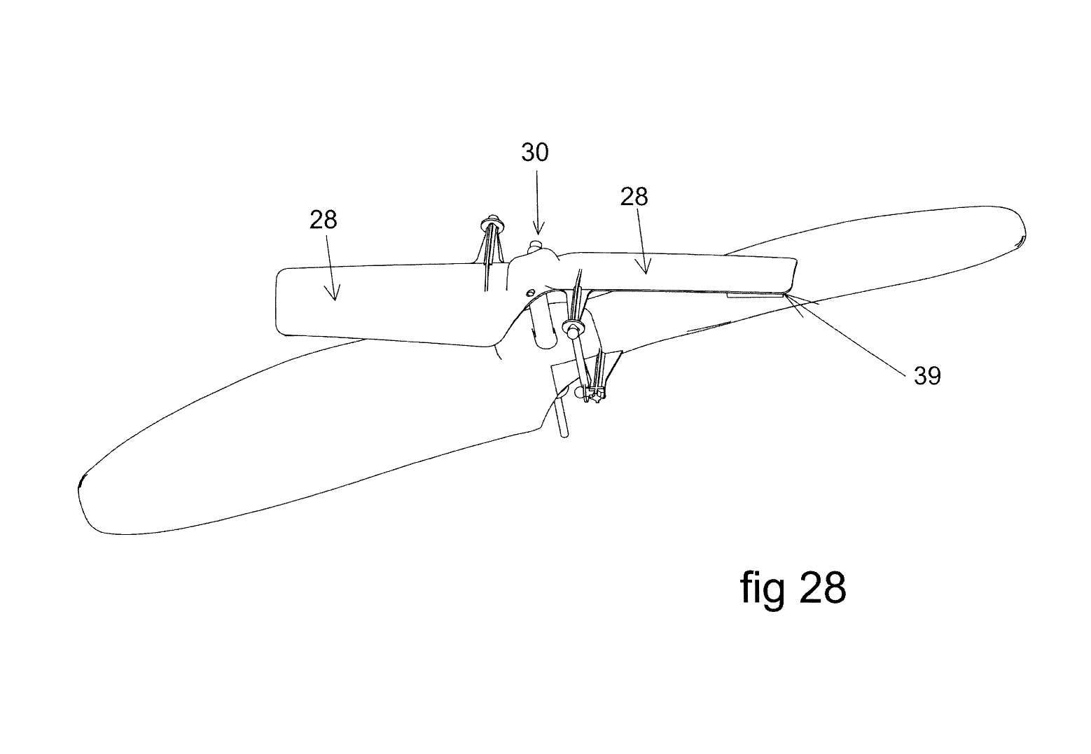

The tilt or angle of incidence A, as shown in detail in FIG. 27, of the propeller blades 12a, in other words the angle A which forms the propeller blades 12a as represented with the plane of rotation 14 of the main rotor 4a, can be adjusted as, the main rotor 4a is hinge-mounted on this rotor shaft 8a by means of a joint, such that the angle between the plane of rotation of the main rotor and the rotor shaft may freely vary. A similar, but not necessarily identical, configuration and operation is provided for the tandem rotor system. For instance, the tandem rotor may be more or less more or less weight in the auxiliary rotor, or a different size or shape relative to the main rotor system.

In the case of the example of a main rotor 4a with two propeller blades 12a, the joint is formed by a spindle 15a of the rotor head 7a. A similar configuration and operation is provided for the tandem rotor system with regard to rotors 4b and 5b, and blades 12b.

The axis 14a of the auxiliary rotor 5a preferably forms an acute angle B with the longitudinal axis 13a of the rotor 4a. A similar configuration and operation is provided for the tandem rotor system with regard to rotors 4b and 5b and blades 12b. There is a similar relationship with axis 13b and 14b.

The helicopter 1 is also provided with an auxiliary rotor 5a which is driven substantially synchronously with the main rotor 4a by the same rotor shaft 8a and the rotor head 7a. A similar configuration and operation is provided for the tandem rotor system with regard to rotors 4b and 5b.

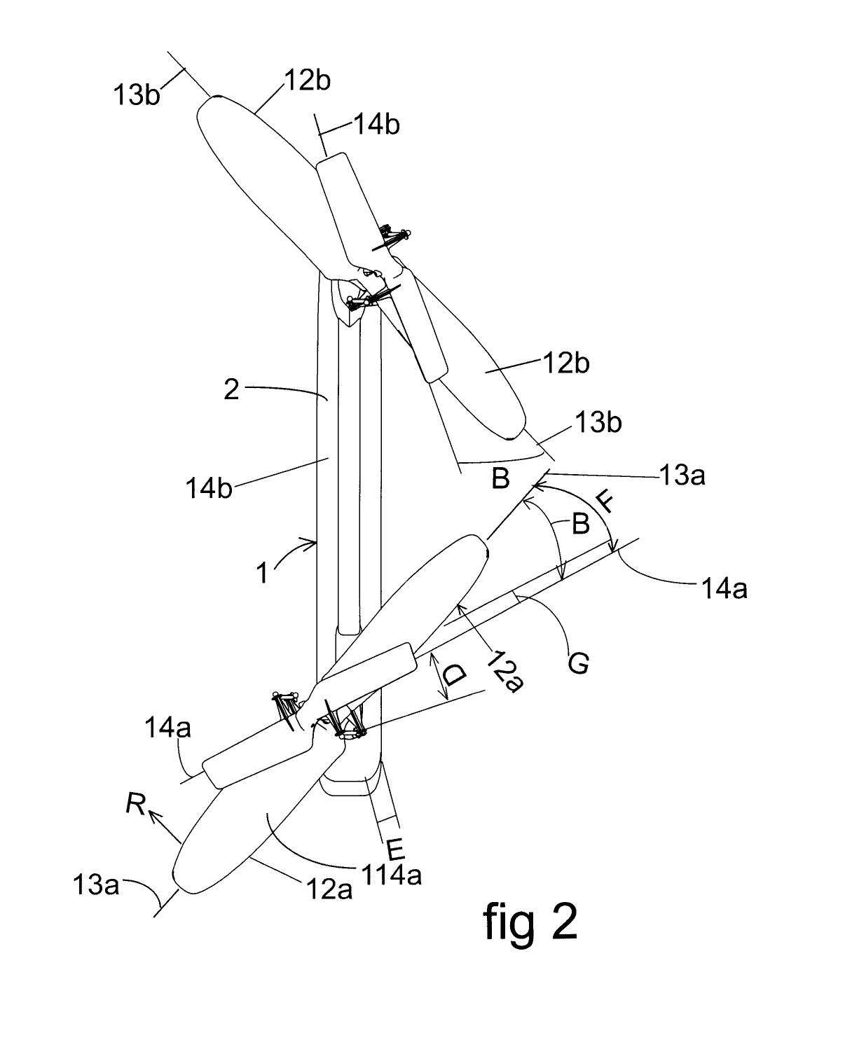

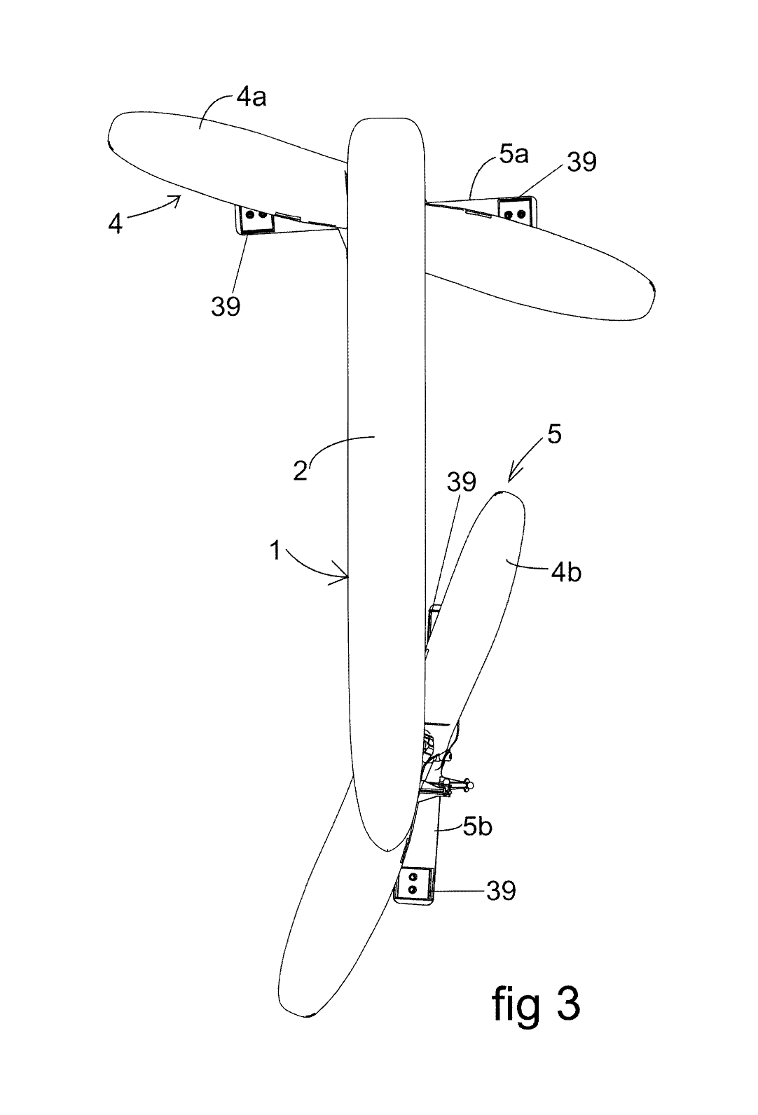

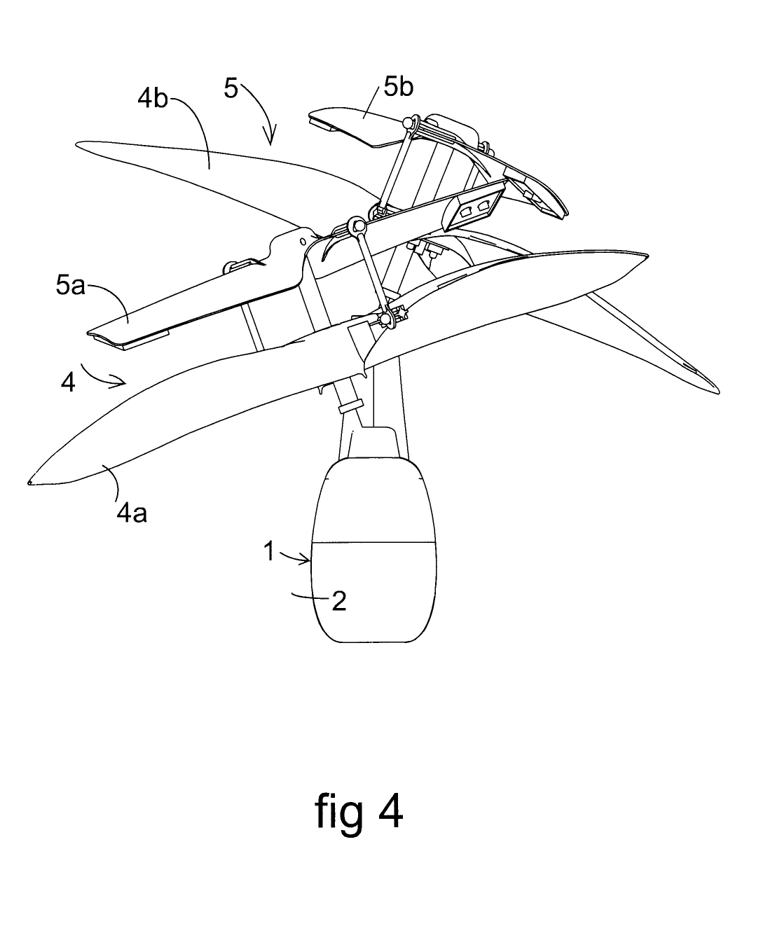

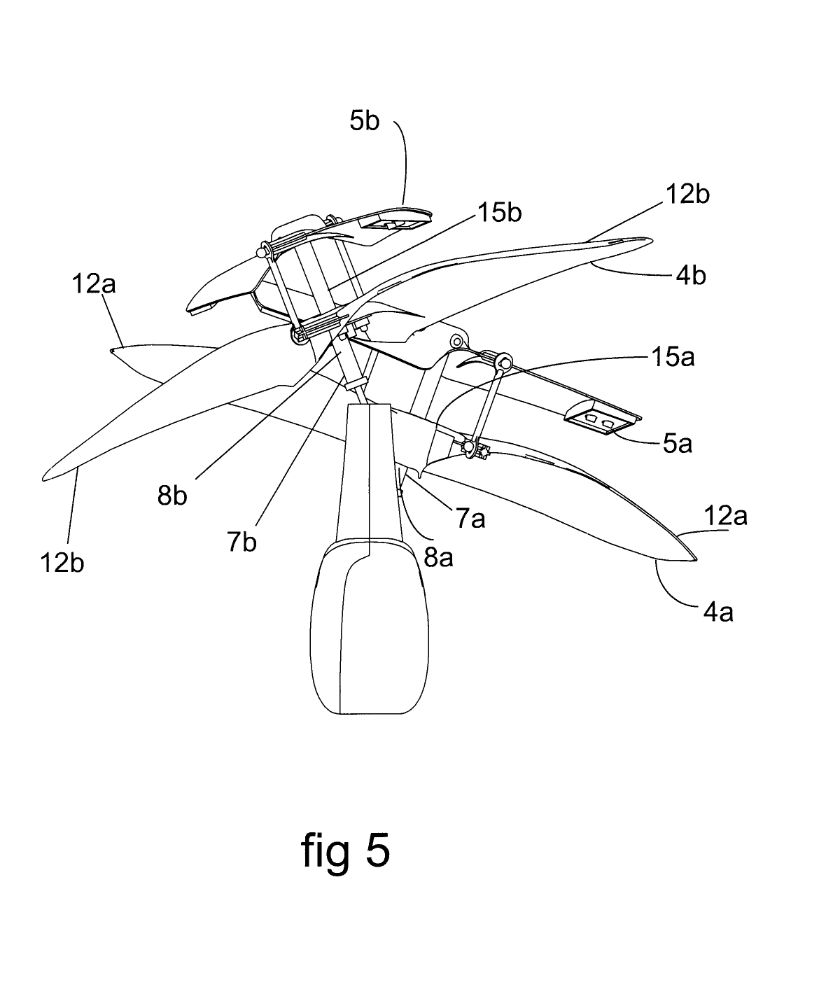

The auxiliary rotor 5a in this case has two vanes which are essentially in line with their longitudinal axis 14a. The longitudinal axis 14a, seen in the sense of rotation R of the main rotor 4a, is essentially parallel to the longitudinal axis 13a of propeller blades 12 of the main rotor 4a or encloses a relatively small acute angle B with the latter. Both rotors 4a and 5a extend more or less parallel on top of one another with their propeller blades 12 and vanes 5a. A similar configuration and operation is provided for the tandem rotor system with regard to rotors 4b and 5b. In FIG. 2 the angle is between axis 14a and the hinging line of rotor 13 going through the spindle 15. The hinging line, not represented, is parallel to the longitudinal axis, but may be varied to alter or tune the stability system. In the case represented the angles B and F are about the same so that the angle G is about Zero degrees.

The diameter of the auxiliary rotor 5a is preferably smaller than the diameter of the main rotor 4a as the vanes 5a have a smaller span than the propeller blades 12, and the vanes 5a are substantially rigidly connected to each other. This rigid whole forming the auxiliary rotor 5a is provided in a swinging manner on an oscillating shaft 30 which is fixed to the rotor head 7a of the rotor shaft 8a. This is directed transversally to the longitudinal axis of the vanes 12 and transversally to the rotor shaft 8a. A similar configuration and operation is provided for the tandem rotor system with regard to rotors 4b and 5b.

The main rotor 4a and the auxiliary rotor 5a are connected to each other by a mechanical link such that the angle of incidence A of at least one of the propeller blades 12 of the main rotor 4a is set. In the given example this link is formed of a rod 31. A similar configuration and operation is provided for the tandem rotor system with regard to rotors 4b and 5b.

This rod 31 is hinge-mounted to a propeller blade 12 of the main rotor 4a with one fastening point 32 by means of a joint 33 and a lever arm 34 and with another second fastening point 35 situated at a distance from the latter, it is hinge-mounted to a vane of the auxiliary rotor 5a by means of a second joint 36 and a second lever arm 37. A similar configuration and operation is provided for the tandem rotor system with regard to rotors 4b and 5b.

The fastening point 32 on the main rotor 4a is situated at a distance D from the axis 16 of the spindle 15 of the propeller blades 12a of the main rotor 4a, whereas the other fastening point 35 on the auxiliary rotor 5a is situated at a distance E from the axis 38 of the oscillatory shaft 30 of the auxiliary rotor 5a. A similar configuration and operation is provided for the tandem rotor system with regard to rotors 4b and 5b.

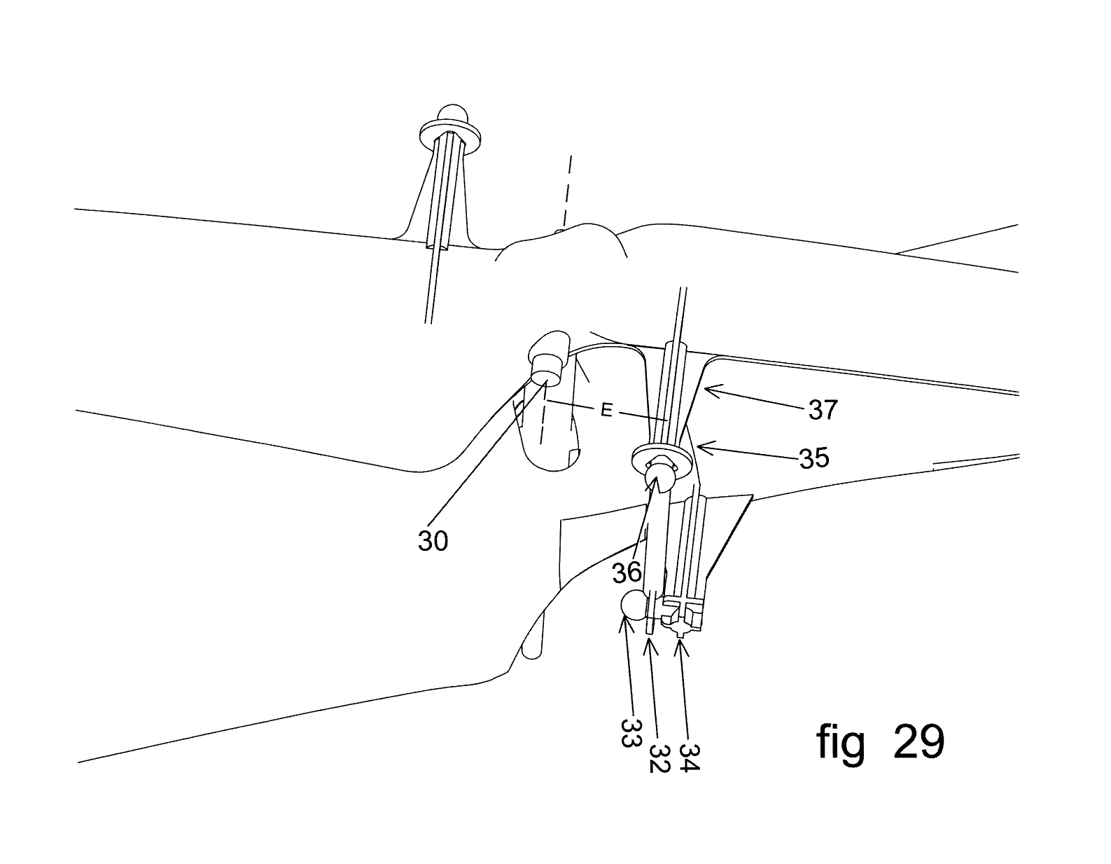

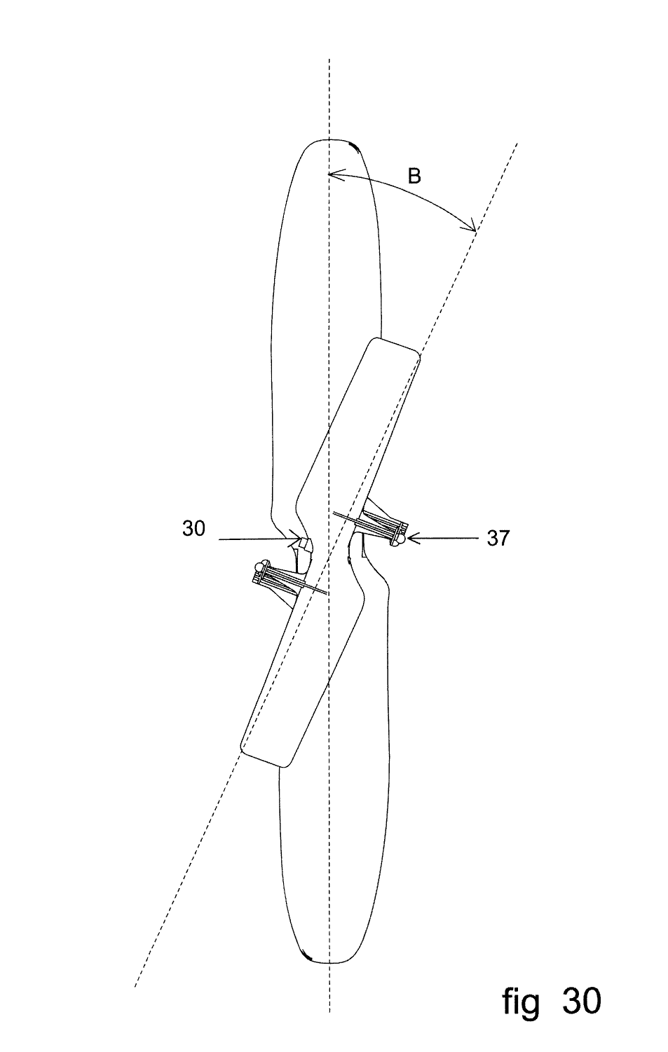

The distance D is preferably larger than the distance E. Distance E is represented in FIGS. 2, 29 and 30 and the distance between the axis of oscillatory shaft 30 and the axis of lever arm 37. Distance D is about double the distance of E. Both fastening points 32 and 35 of the rod 31 are situated. This is in the sense of rotation R on the same side of the propeller blades 12a of the main rotor 4a or of the vanes 28 of the auxiliary rotor 5a. In other words they are both situated in front of or at the back of the propeller blades 12a and vanes 5a, as seen in the sense of rotation. A similar configuration and operation is provided for the tandem rotor system with regard to rotors 4b and 5b.

Also preferably, the longitudinal axis 14a of the vanes 5a of the auxiliary rotor 5a, seen in the sense of rotation R, encloses an angle B with the longitudinal axis 13a of the propeller blades 12a of the main rotor 4a, which enclosed angle B is in the order, of magnitude of about 10° to about 17°, whereby the longitudinal axis 14a of the vanes 5a leads the longitudinal axis 13a of the propeller blades 12a, seen in the sense of rotation R. Different angles in a range of, for example, 5° to 25° could also be in order. A similar configuration and operation is provided for the tandem rotor system with regard to rotors 4b and 5b.

The auxiliary rotor 5a is provided with two stabilizing weights 39 which are each fixed to a vane 5a at a distance from the rotor shaft 8. A similar configuration and operation is provided for the tandem rotor system with regard to rotors 4b and 5b.

Further, the helicopter 1 is provided with a receiver, so that it can be controlled from a distance by means of a remote control, which is not represented. A similar configuration and operation is provided for the tandem rotor system with regard to rotors 4b and 5b.

As a function of the type of helicopter, it is possible to search for the most appropriate values and relations of the angles B by experiment; the relation between the distances D and E and G and F which are described below; the size of the weights 39 and the relation of the diameters between the main rotor 4a and the auxiliary rotor 5a so as to guarantee a maximum auto stability. A similar configuration and operation is provided for the tandem rotor system with regard to rotors 4b and 5b.

The operation of the improved helicopter 1 according to the disclosure is as follows:

In flight, the rotors 4a and 5a are driven at a certain speed, as a result of which a relative air stream is created in relation to the rotors, as a result of which the main rotors 4a and 5a generate an upward force so as to make the helicopter 1 rise or descend or maintain it at a certain height, and the rotors develop a laterally directed force which is used to steer the helicopter 1. A similar configuration and operation is provided for the tandem rotor system with regard to rotors 4b and 5b.

It is impossible for the main rotor 4a to adjust itself, and it will turn in the plane 114a in which it has been started, usually the plane perpendicular to the rotor shaft 8a. Under the influence of gyroscopic precession, turbulence and other factors, it will take up an arbitrary undesired position if it is not controlled. A similar configuration and operation is provided for the tandem rotor system with regard to rotors 4b and 5b.

The surface of rotation of the auxiliary rotor 5a may take up another inclination in relation to the surface of rotation 114a of the main rotor 4a, whereby both rotors 5a and 4a may take up another inclination in relation to the rotorshaft 8a.

This difference in inclination may originate in any internal or external force or disturbance whatsoever.

In a situation whereby the helicopter 1 is hovering stable, on a spot in the air without any disturbing internal or external forces, the auxiliary rotor 5a keeps turning in a plane which is essentially perpendicular to the rotor shaft 8a.

If, however, the body 2 is pushed out of balance due to any disturbance whatsoever, and the rotor shaft 8 turns away from its position of equilibrium, the auxiliary rotor 5a does not immediately follow this movement, since the auxiliary rotor 5a can freely move round the oscillatory shaft 30.

The main rotor 4a and the auxiliary rotor 5a are placed in relation to each other in such a manner that a swinging motion of the auxiliary rotor 5a is translated almost immediately in the pitch or angle of incidence A of the propeller blades 12 being adjusted. A similar configuration and operation is provided for the tandem rotor system with regard to rotors 4b and 5b.

For a two-bladed main rotor 4a, this means that the propeller blades 12 and the vanes 28 of both rotors 4a and 5a must be essentially parallel or, seen in the sense of rotation R, enclose an acute angle with one another of for example 10° to 17° in the case of a large main rotor 4a and a smaller auxiliary rotor 5a. A similar configuration and operation is provided for the tandem rotor system with regard to rotors 4b and 5b.

This angle can be calculated or determined by experiment for any helicopter 1 or per type of helicopter, and this angle can be different for the rotor and the tandem rotor.

If the axis of rotation 8a takes up another inclination than the one which corresponds to the above-mentioned position of equilibrium in a situation whereby the helicopter 1 is hovering, the following happens: A similar configuration and operation is provided for the tandem rotor system with regard to rotors 4b and 5b.

A first effect is that the auxiliary rotor 5a will first try to preserve its absolute inclination, as a result of which the relative inclination of the surface of rotation of the auxiliary rotor 5a in relation to the rotor shaft 8a changes. A similar configuration and operation is provided for the tandem rotor system with regard to rotors 4b and 5b.

As a result, the rod 31 will adjust the angle of incidence A of the propeller blades 12, so that the upward force of the propeller blades 12 will increase on one side of the main rotor 4a and will decrease on the diametrically opposed side of this main rotor. A similar configuration and operation is provided for the tandem rotor system with regard to rotors 4b and 5b.

Since the relative position of the main rotor 4a and the auxiliary rotor 5a are selected such that a relatively immediate effect is obtained. This change in the upward force makes sure that the rotor shaft 8a and the body 2 are forced back into their original position of equilibrium.

A second effect is that, since the distance between the far ends of the vanes and the plane of rotation 14 of the main rotor 4a is no longer equal and since also the vanes 28 cause an upward force, a larger pressure is created between the main rotor 4a and the auxiliary rotor 5a on one side of the main rotor 4a than on the diametrically opposed side. A similar configuration and operation is provided for the tandem rotor system with regard to rotors 4b and 5b.

A third effect plays a role when the helicopter begins to tilt over to the front, to the back or laterally due to a disturbance. Just as in the case of a pendulum, the helicopter will be inclined to go back to its original situation. This pendulum effect does not generate any destabilizing gyroscopic forces as with the known helicopters that are equipped with a stabilizer bar directed transversally to the propeller blades of the main rotor. It acts to reinforce the first and the second effect.

The effects have different origins but have analogous natures. They reinforce each other so as to automatically correct the position of equilibrium of the helicopter 1 without any intervention of a pilot.

If necessary, this aspect of the disclosure may be applied separately, just as the aspect of the auxiliary rotor 5a can be applied separately to a helicopter having a main rotor 4a combined with an auxiliary rotor 5a. A similar configuration and operation is provided for the tandem rotor system with regard to rotors 4b and 5b.

In practice, the combination of both aspects makes it possible to produce a helicopter which is very stable in any direction and any flight situation and which is easy to control, even by persons having little or no experience.

It is clear that the main rotor 4a and the auxiliary rotor 5a are not necessarily be made as a rigid whole. The propeller blades 12a and the vanes 5a can also be provided on the rotor head 7a such that they are mounted and can rotate relatively separately. In that case, for example, two rods 31 may be applied to connect each time one propeller blade 12a to one vane 5a. A similar configuration and operation is provided for the tandem rotor system with regard to rotors 4b and 5b.

It is also clear that, if necessary, the joints and hinge joints may also be realized in other ways than the ones represented, for example by means of torsion-flexible elements.

In the case of a main rotor 4a having more than two propeller blades 12, one should preferably be sure that at least one propeller blade 12a is essentially parallel to one of the vanes 5a of the auxiliary rotor. The exact angle is determined by testing and can be different from zero. The joint of the main rotor 4a is preferably made as a ball joint or as a spindle 15 which is directed essentially transversely to the axis of the oscillatory shaft 30 of the auxiliary rotor 5a and which essentially extends in the longitudinal direction of the one propeller blade 12a concerned which is essentially parallel to the vanes 5a. A similar configuration and operation is provided for the tandem rotor system with regard to rotors 4b and 5b.

In another format, the helicopter comprises a body, and a main rotor with propeller blades which is driven by a rotor shaft on which the blades are mounted. An auxiliary rotor is driven by the rotor shaft of the main rotor and is provided with vanes from the rotor shaft in the sense of rotation of the main rotor.

The auxiliary rotor is mounted in a swinging relationship on an oscillatory shaft and the swinging motion being relatively upwardly and downwardly about the auxiliary shaft. The auxiliary shaft is provided essentially transverse to the rotor shaft of the main rotor. The main rotor and the auxiliary rotor are connected to each other by a mechanical link, such that the swinging motion of the auxiliary rotor controls the angle of incidence of at least one of the propeller blades of the main rotor.

The angle of incidence of the rotor in the plane of rotation of the rotor and the rotor shaft may vary. An auxiliary rotor rotatable with the rotor shaft is for relative oscillating movement about the rotor shaft. Different relative positions are such that the auxiliary rotor causes the angle of incidence the main rotor to be different. A linkage between the main and auxiliary rotor causes changes in the position of the auxiliary rotor to translate to changes in the angle of incidence.

The propeller blades of the main rotor and the vanes of the auxiliary rotor respectively are connected to each other with a mechanical linkage that permits the relative movement between the blades of the propeller and the vanes of the auxiliary rotor. A joint of the main rotor to the propeller blades is formed of a spindle that is fixed to the rotor shaft of the main rotor.

The mechanical link includes a rod hinge mounted to a vane of the auxiliary rotor with one fastening point and is hinge-mounted with another fastening point to the propeller blade of the main rotor.

Tandem helicopters have two rotors of more or less similar diameter the rotors are disposed along the helicopter body typically one at each end. The tip rotor paths may be overlapping to a certain extend. In that case one rotor is positioned higher than the other to avoid that the rotor blades collide.

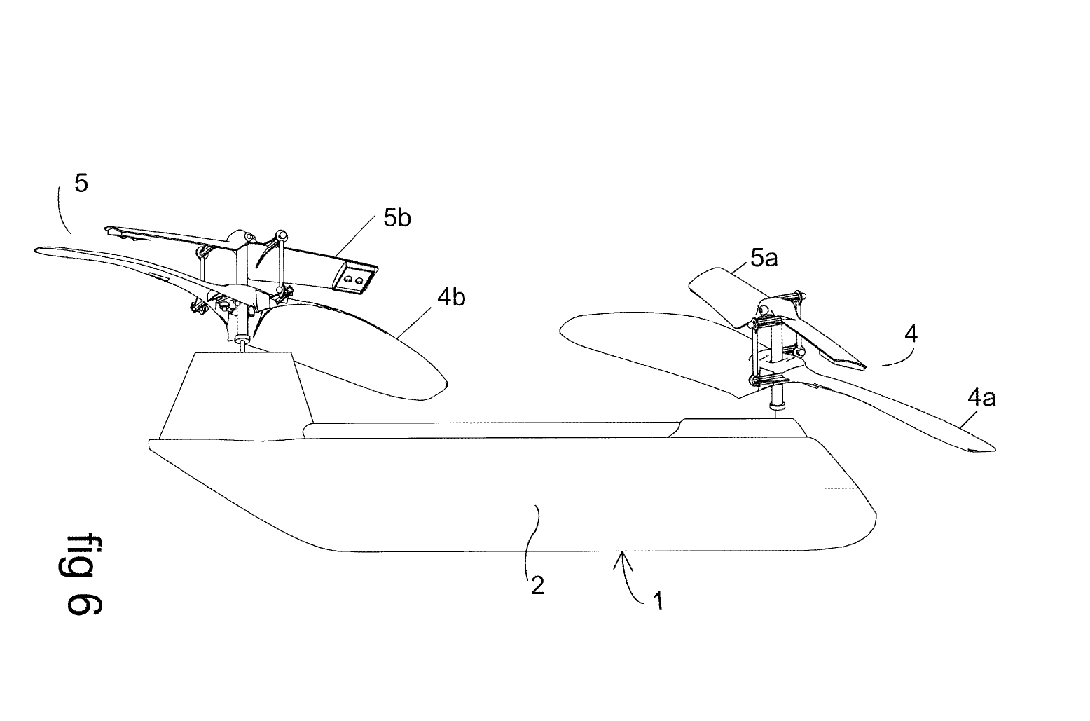

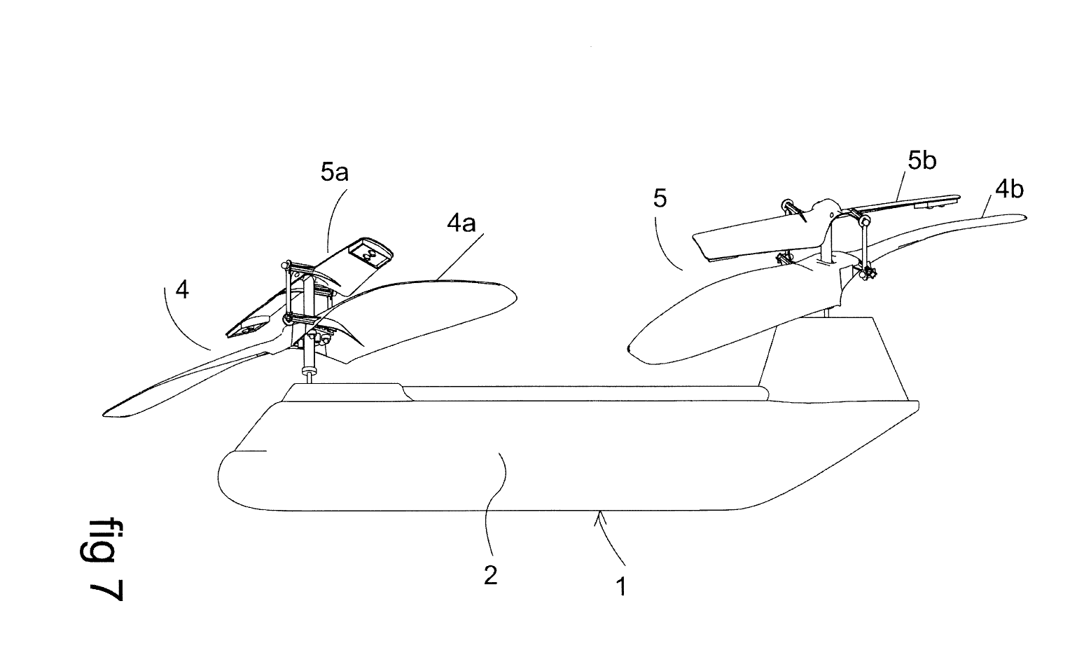

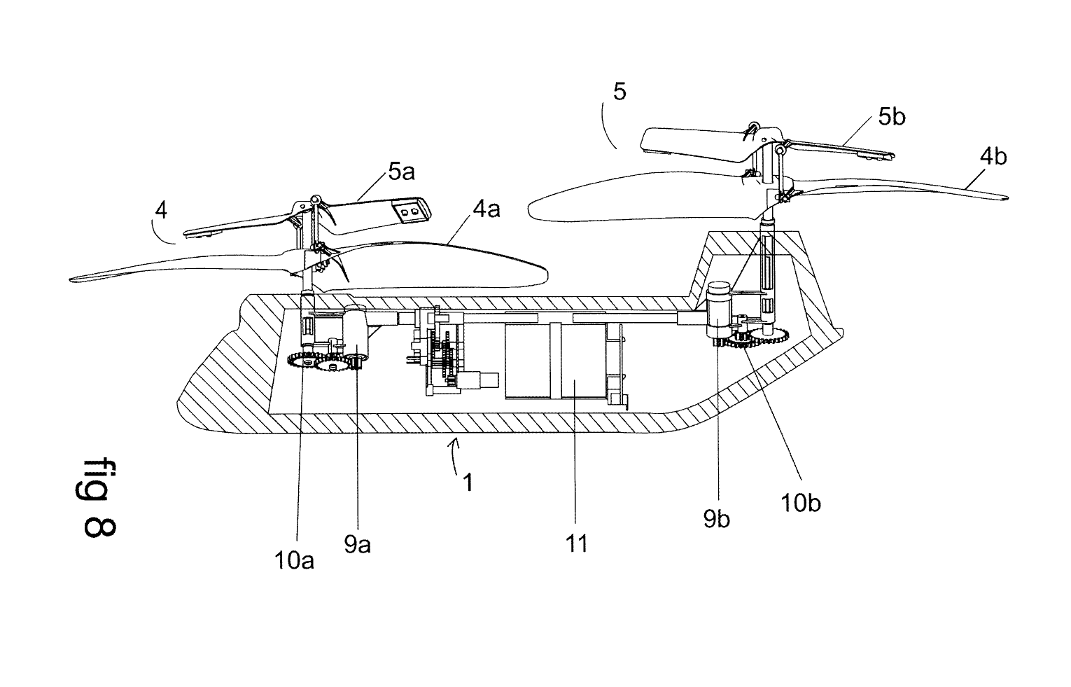

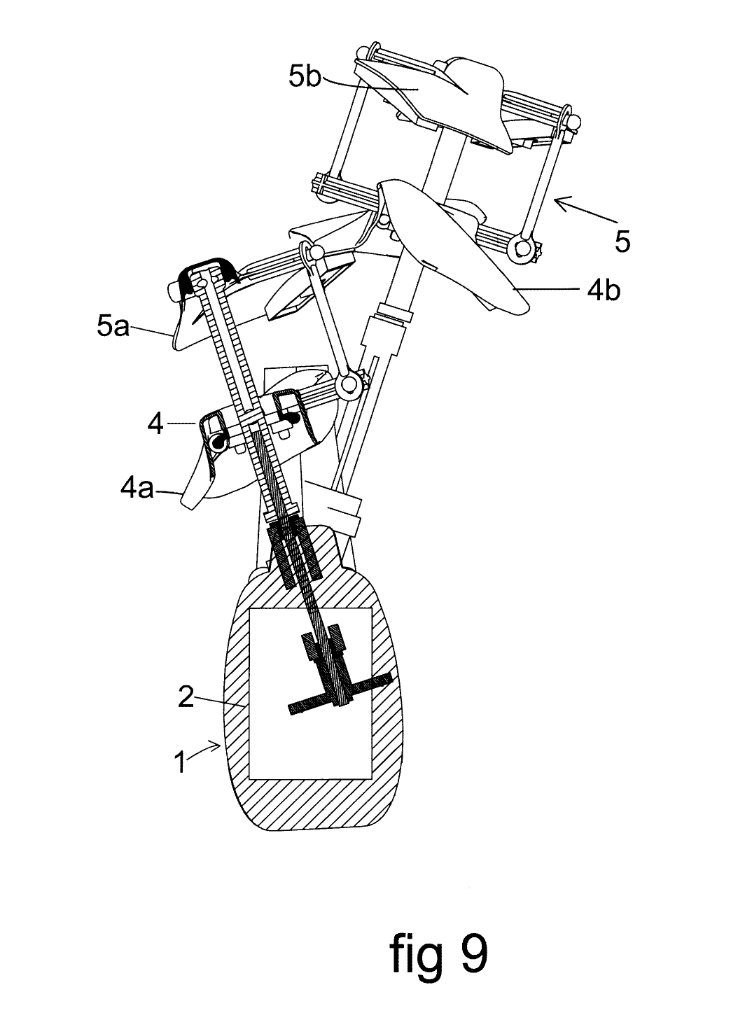

FIG. 7 represents a typical configuration. Both rotors exercise a lift force to compensate for the weight of the body. If the combined lift force exceeds the weight of the tandem, there will be lift off.

Stability and equilibrium of the tandem helicopter can be analyzed in 4 dimensions that need control to keep the tandem on a spot in space, or along a desired trajectory. These controls can be active (by the pilot, or assisted by electronics), or passive (by aerodynamic and mechanical design).

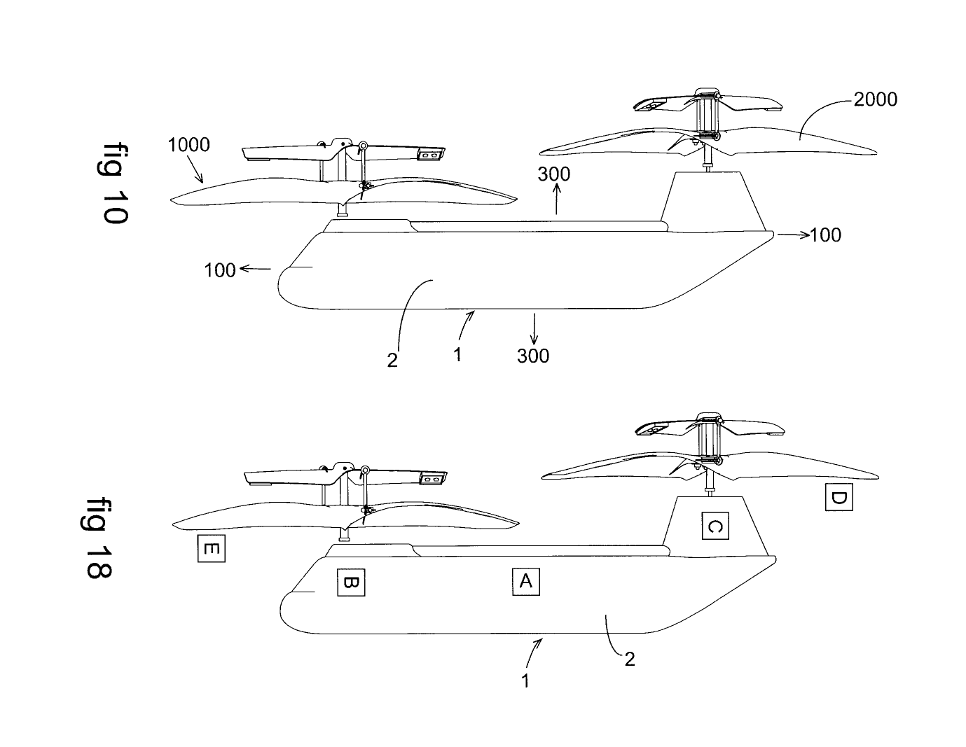

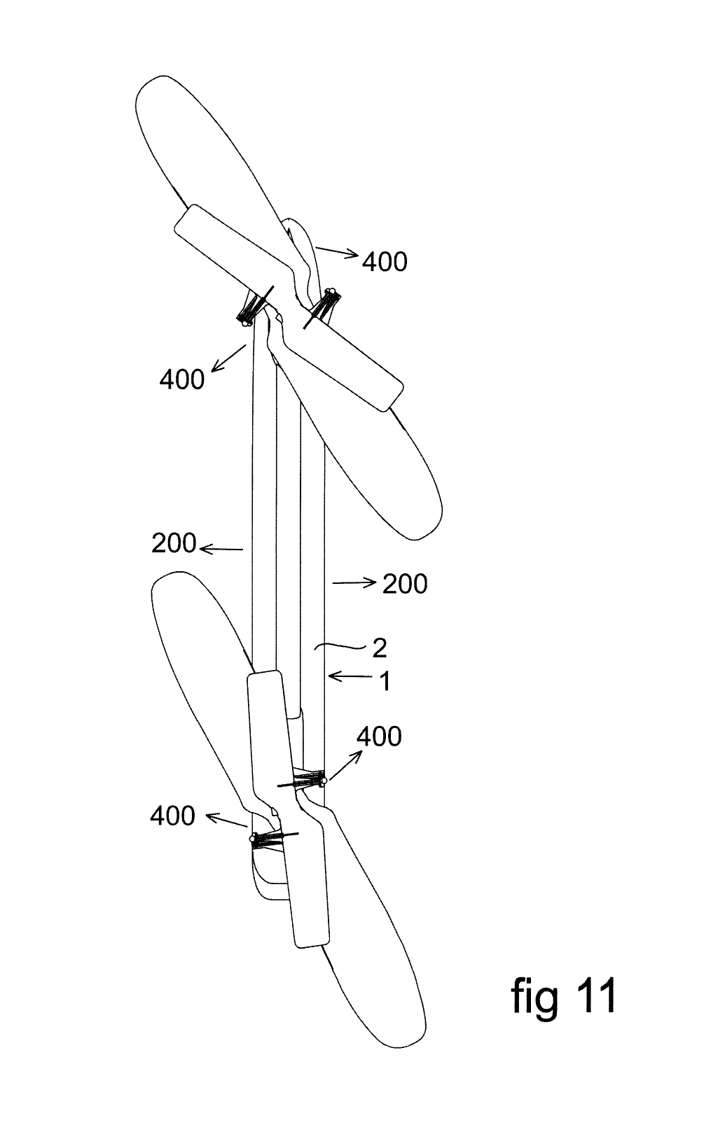

These dimensions are represented in FIGS. 10 and 11.
forward/backward (100)
sideward left/right (200)
up/down vertical (300)
yaw (400)

These 4 dimensions have no absolute reference in space. Therefore, constant corrections have to be performed in flight to keep the tandem flying as desired. Both in real size and hobby/toy tandems, it is generally known that this implies very specific and complicated set of stabilizing devices like gyro's and feedback systems, on top of permanent pilot controls.

To accomplish stability in dimension 100 and 200, and to a certain extent dimension 400, the tandem helicopter is equipped with autostable rotors as described in FIGS. 10 and 17. This rotor system wants the helicopter to resist by rotor design any deviation in dimensions 100 and 200, and to a certain extent dimension 400.

Dimension 300 usually does not require anything more than the input of the pilot to choose and keep the desired altitude, or climbing and descending speed.

Dimension 400, the yaw around the vertical axis needs to deal with the torque effects of the main rotors, and any external disturbances that induce yaw changes.

A rotor produces torque as a side effect of the thrust generated. This torque will go against the direction of rotation of the rotor. In a classical helicopter with main and tail rotor, this torque is compensated by the tail rotor. If no such compensation existed, the body would rotate around the vertical axis in a direction against the rotation of the rotor. The main rotor turning in a clockwise direction induces a torque on the body in counter clockwise direction. To keep the body from turning permanently around its vertical axis, the tail rotor is added to compensate for torque with a sideward force.

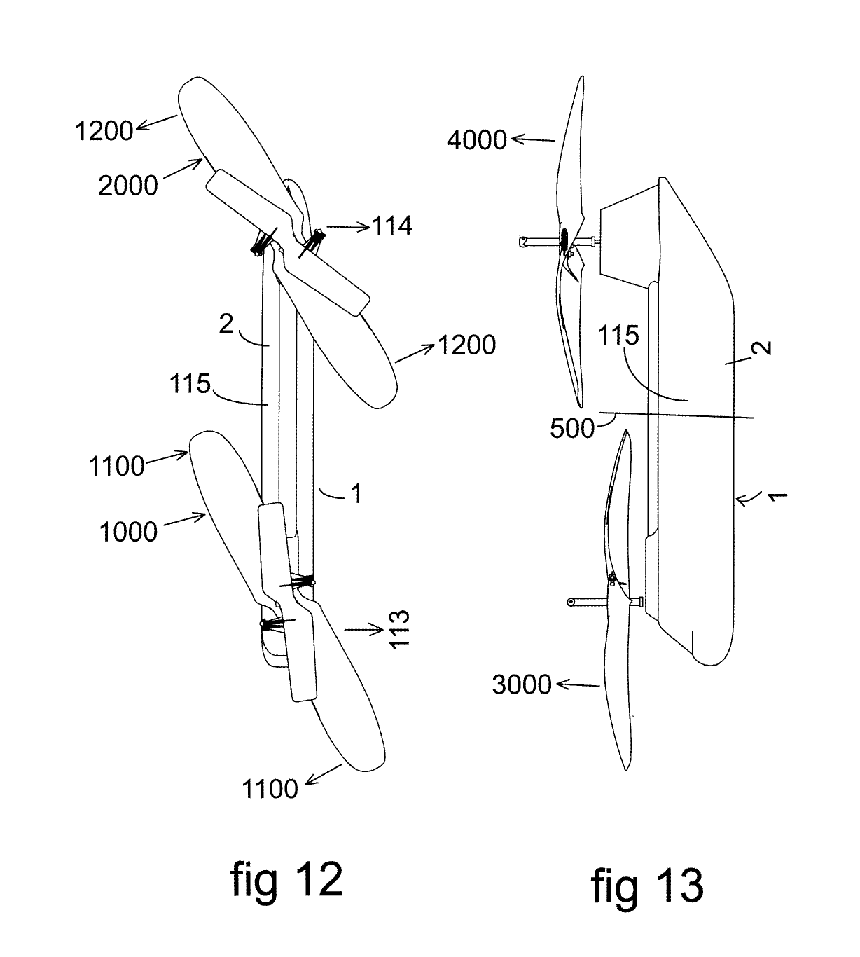

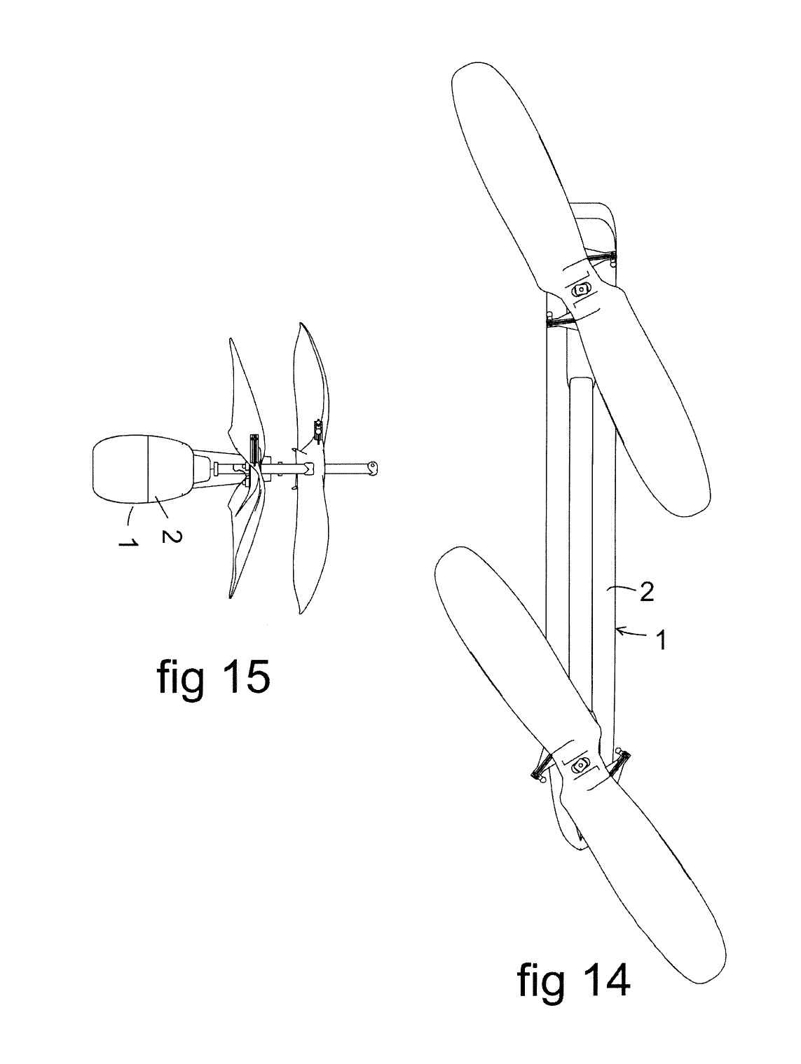

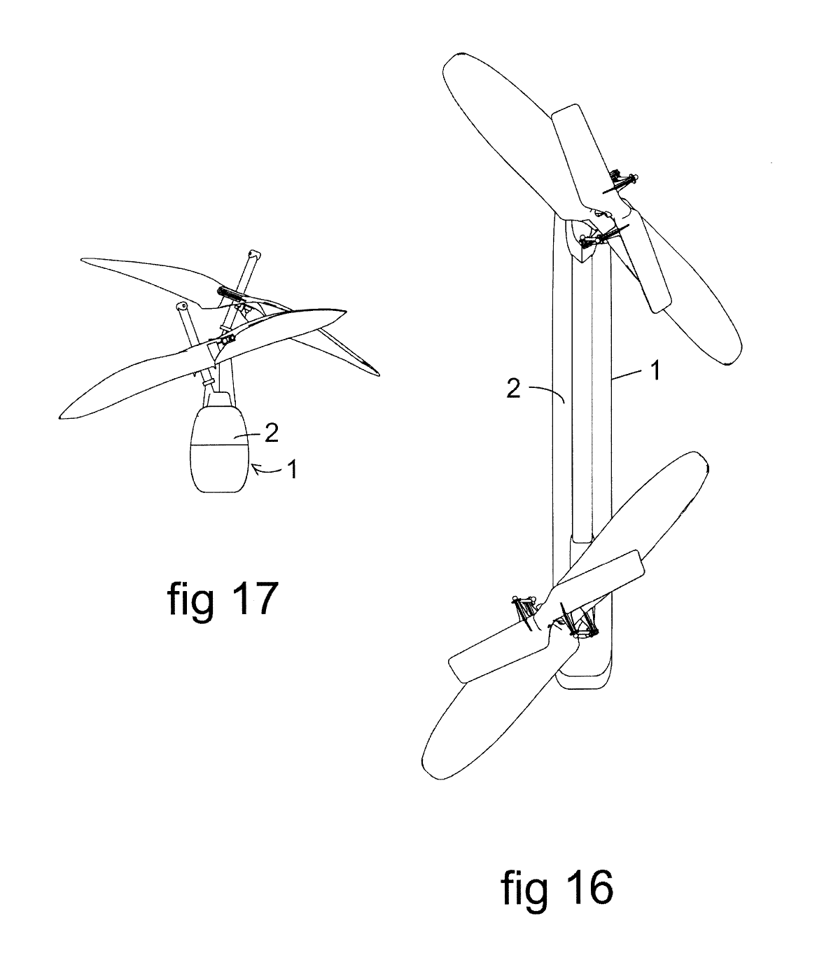

In tandem helicopters as shown in FIGS. 12 and 13, the two rotors are turning so that the rotation of one rotor 1000 in direction 1100 (clockwise) creates a torque on the body 2 in direction 113 (counterclockwise) around the center axis 500. The rotation of the other rotor 2000 in direction 1200 (counterclockwise) creates a torque on the body in direction 114 (clockwise) around the center axis of that rotor. This is illustrated in FIG. 13.

Torque 113 and torque 114 are in a perfect case of equal size, however of opposite direction. Therefore, they annulate and the body of the tandem does not rotate by itself.

Yaw Behavior

That perfect case assumes that both rotors turn at identical speed, have identical drag, have identical lift, and that no external disturbances like air gusts and turbulences have influence.

In reality, none of this is absolutely true. So although the body more or less keeps its yaw position, it will constantly and randomly change direction because of all the above factors. It is up to the pilot, assisted by eventual gyro stabilizer, or other devices, to correct for that.

The smaller the model is, the more these factors have effect due to the lower inertia of the tandem, requiring speedier correction input from the pilot.

Yaw Instability

The counter rotation configuration annulates torque on the body. However, it causes a problem related to yaw stability.

Consider art tandem helicopter in a hovering position, and suppose it is in perfect still position in hover flight. This is shown in FIG. 13. The rotor 1000 and rotor 2000 turn in opposite direction. The rotor 1000 and rotor 2000 create identical lift forces 300 and 400. The body is horizontal.

Consider the same tandem helicopter in hovering position, and suppose that as the result of any of the effects described (air gusts, turbulence, slight change in relative rotor rpm, etc) the body starts turning in one direction (clockwise in this example), around the vertical centerline 500 of the tandem helicopter of FIG. 13. The rotor 1000 and rotor 2000 turn in opposite directions. Because of the body rotation and direction of rotation, rotor 1000 increases its rotation speed while rotor 2000 decreases rotation speed relative to the air. Because lift force at constant pitch varies with rotation speed, the rotor 1000 and rotor 2000 create now different lift forces, 3000 is higher and 4000 is lower. Because of the difference in the lift forces, the body is no longer in equilibrium and tend to raise the front end where rotor 1000 is and lower the back end adjacent to rotor 2000. Because of the difference in lift forces, the torque on rotor 1000 increases, and the torque on rotor 2000 decreases.

The changes in torque are of the same amount but in a different direction, so they balance out each other and do not influence the yaw disturbance.

When the body 2 starts turning in one direction (clockwise in this example), around the vertical centerline 500 of the tandem helicopter (FIG. 13), then the lift force along the span of one rotor varies along the position relative to the body and the body rotation axis. The increase/decrease in lift will be higher the further from the body rotation axis. This further amplifies the destabilizing of the helicopter and raises the front end where rotor 1000 is and lowers the back end adjacent to rotor 2000 even more.

The body 2 no longer stays horizontal and raises the high lift rotor and lower the low lift rotor. The increase in lift of rotor 1000 is accompanied by a move of the center of lift further from the centerline of the helicopter (longer lever). The associated decrease in lift of rotor 2000 is accompanied by a move of the center of lift closer to the center line of the helicopter (shorter lever). Both effects combined reinforce the tendency to incline backwards caused by the differences in thrust as such. This inclination results in unwanted and parasite backward speed. That further destabilizes the tandem on top of the initial yaw disturbance.

Left-Right Asymmetry in Counter-Rotating Configuration

The counter-rotating rotors create a tandem that is symmetrical in aerodynamic, gyroscopic effects. This is supposed to facilitate lay-out of the components, the body and the overall design of the body.

However, counter-rotating rotors have an asymmetric effect on the sideward thrust on the tandem body. Rotor 1000 and rotor 2000 are counter-rotating. The rotors create a down-flow of air to create lift, but that down flow has a spiraling component in the direction of rotation of the rotor. When the tips of both rotors reach the center of the body 2, this spiraling air is hitting the side of the body 2 with an airflow component.

A 3 stage effect is created on the tandem:
a. The body 2 sees a one sided thrust force, this side force tends to push the helicopter in the direction of force 4000.
b. This force 4000 makes the tandem incline to one side and both rotors incline in an equal amount.

c. The lift force is no longer vertical but has a horizontal vector component. This vector pushes the tandem to the opposite direction. This increases the sideward force that hits the body 2.

So, in spite of the apparent symmetry of the counter rotating configuration, the tandem will have a strong tendency to lean over and slip to one side. This tendency varies with the surface of the body, the weight of the tandem, the rotation speed of the rotors, the relative distance from the rotor(s) to the body, the position of the center of gravity. Overall, this tendency increases with a decrease in weight of the tandem. A possible solution is to move the center of gravity sideward to align the body back to vertical.

The unidirectional tandem rotors are illustrated with reference to the figures.

The counter rotation rotors on a tandem configuration, where the rotor axes are at a certain distance from each other, have destabilizing and asymmetrical effects. Yaw changes induce fore/aft drift, and the rotor pushes the tandem to lean over and slip. The combination of these effects makes it very hard to find a natural trim of the tandem for stable hover without pilot correction, or gyro, etc., on the fore/aft and sideways dimension.

The solution is to have the rotors spinning in the same direction. When an external yaw disturbance causes the body to rotate, then both rotors will see the same amount of decrease or increase in rotation speed equal to the rotation speed of the body.

Lift forces on both rotors change equally, so the body stays horizontal. This change in lift force does make the tandem ascent or descent. However, because there is no body inclination, this is not a destabilizing effect.

The sideward spiraling forces of the rotor thrust still hit the body 2, but now in opposite direction such that they cancel out. The body does not incline, nor slips sideways.

The torque of rotor 1000 and rotor 2000, in this case of clockwise rotation of both rotors, now adding up into a new torque. The rotors are inclined in such a way, namely amount and direction that a horizontal thrust force on both rotor axis creates a counter torque that cancels out the sum of the rotor torque.

The thrust on rotor 1000 has a horizontal component centered on the rotor 1000 axis. The thrust on rotor 2000 has a horizontal component centered on the rotor 1000 axis. Those two forces exercise a torque on the body 2 in the opposite direction of the first torque. The size of thrusts depends on the inclination of the rotors 1000 and 2000, and so does the resulting torque. When torques are identical in size, they cancel out and prevent the body from turning around it's vertical axis.

The required degree of inclination of the rotors depends mainly on:
the type of rotor shape and airfoil;
the horizontal distance between both rotors; and
the shape of the body 2 which also has an influence on the angle.

This inclination is relatively small and is independent of rpm. When the rpm changes higher, for example, so does the torque induced by the rotor. The higher rpm means a higher lift and a higher horizontal thrust component and thus a higher corrective thrusts. It is possible to increase rpm at one rotor, the rear rotor for example, and decrease the rpm on the other rotor, the front rotor, without any asymmetrical torque effects that cause the body to turn around or yaw. This makes it possible to move the helicopter forward or backward using this method without the need for yaw correction.

Counter rotating rotors on tandem helicopters create tendency to drift in the for/after and sideway direction, and induces inclination of the body. This leads to instability in flight unless a pilot, mechanical or electronic system creates the necessary corrective input.

The current disclosure uses two rotors at a certain horizontal distance one from another, rotating in the same direction. Those rotors are inclined such that they compensate for the torque effects induced by the spinning rotors. The effects of yaw (pilot induced or uninitiated/unwanted) no longer create drift in the for/after dimension, nor does it cause undesired inclination of the body. The spiral thrust no longer inclines and drifts the body sideways.

The body design is another element enhancing the stability against undesired yaw affects.

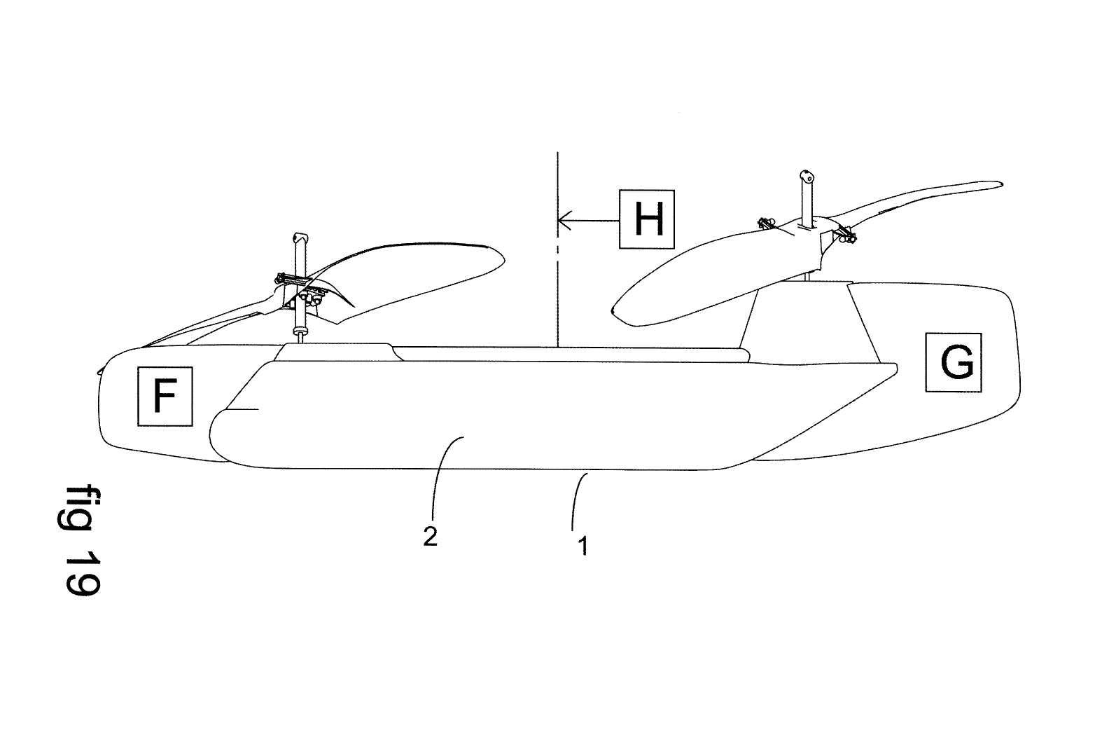

The body shape of a typical tandem helicopter is determined to an extent by functional matters. As shown in FIG. 18, there is a need to interconnect both rotors and their drive systems, and that leads to a long and mainly rectangular central part A. Then there is a typical nose end B added to house the pilot(s) and a tail end with increased surface C to act as a directional stabilizer for forward flight. This is similar to the fins on an arrow.

The size of B and C, mainly the part that sticks out under the E and D ends of the rotors has an impact on yaw stability.

A shape shown in FIG. 19 with extension fins F and G has a relatively higher yaw stability, and resists and even stops any unwanted yaw effects due to asymmetry in torque between the rotors and external disturbances. Furthermore, when the pilot gives a wanted yaw input, this shape dampens the effect, avoid overshooting of the effect versus the desired effect, and acts as a ‘damper’. The result is more comfort for the pilot, and a much more stable tandem helicopter.

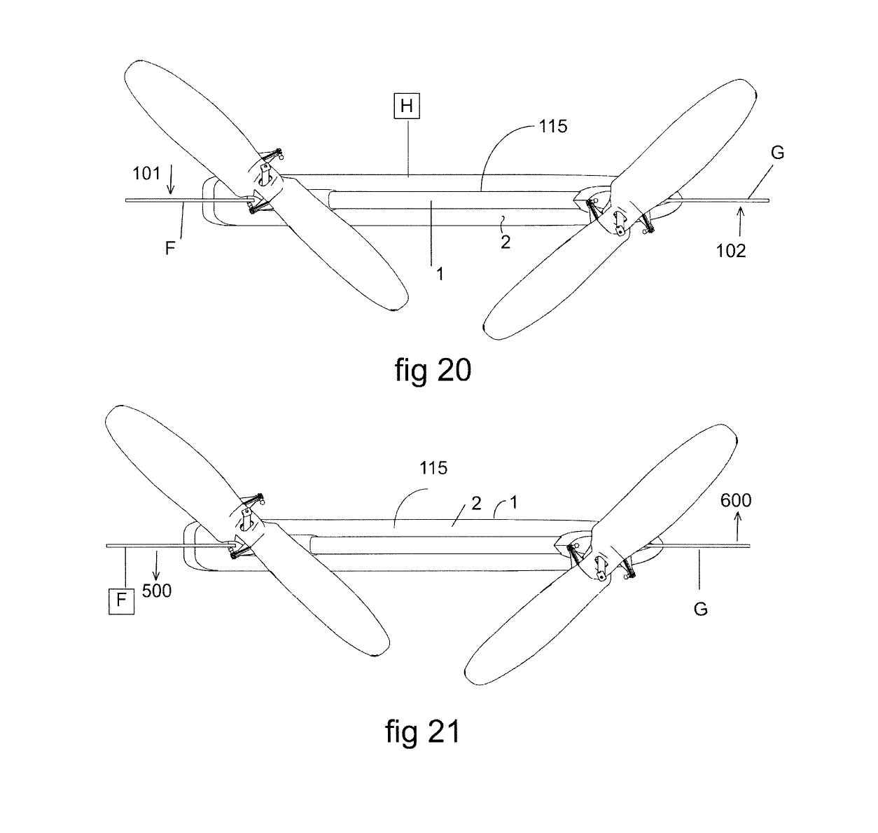

The reasons why this works are at least 3 fold. First, the surfaces F and G are at the outermost distance from the centerline H compared with the rest of the body. This is further illustrated in FIG. 20. In case of yaw around the centerline H clockwise, for example, the lateral surfaces F and G operate like aerodynamic brakes, because they have to overcome the pressure of the air 101 and 102 hitting the surfaces due to the yaw rotation.

This braking effect slows down the yaw rotation, and eventually stops it. The shape of F and G can be any desired profile.

Secondly, the surfaces F and G are in the downwards airflow as generated by the two rotors, and tend to align to that downward force. This is a function similar to a vane effect.

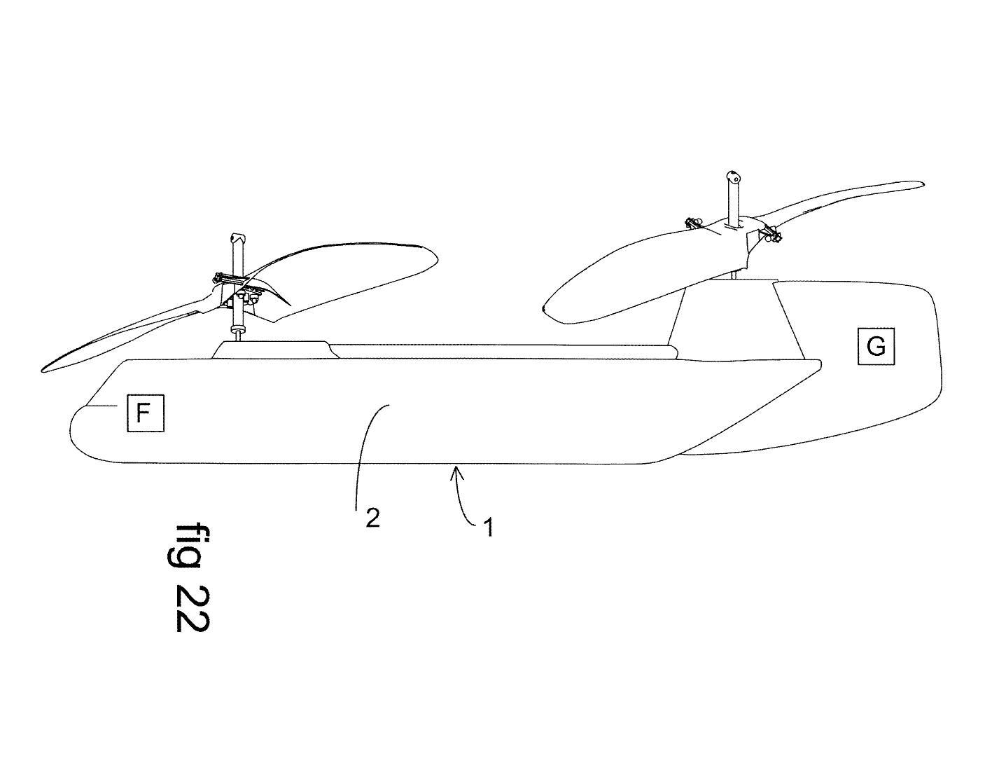

Thirdly, If the body rotates, then the surfaces of fins F and G will see the downflow from the rotor thrust combined with the movement as result of the yaw, as a combined flow that no longer is in line with the surface of fins F or G but with a certain angle of attack. This angle of attack creates a lift force perpendicular to the surfaces of fins F and G opposite to the direction of movement. These lift forces 500 and 600 counter the yaw movement and further dampen it. See FIG. 21.

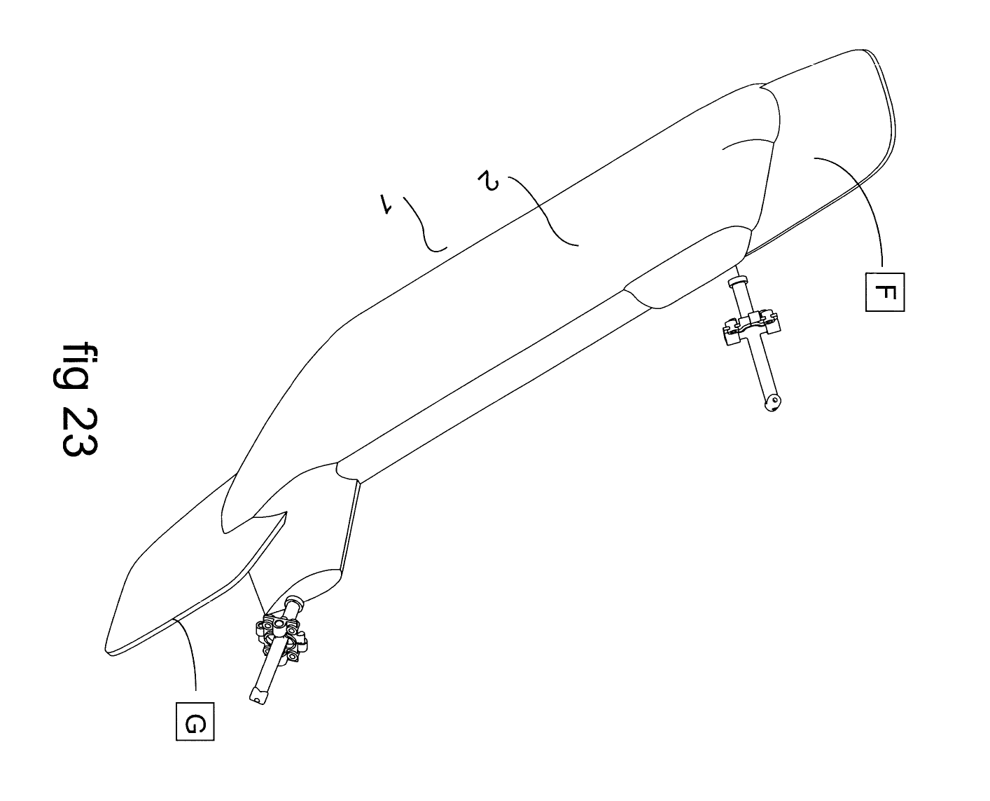

The shape of the fin parts F and G can be any desirable profile. As is shown in FIG. 22, the front extension is integrated in the body design. The back fin G end can be a transparent foil of plastic.

Alternatively, both extension fins F and G are made of transparent plastic so as to respect a desired shape of a body and yet to have the effect of yaw stabilization. This is shown in FIG. 23.

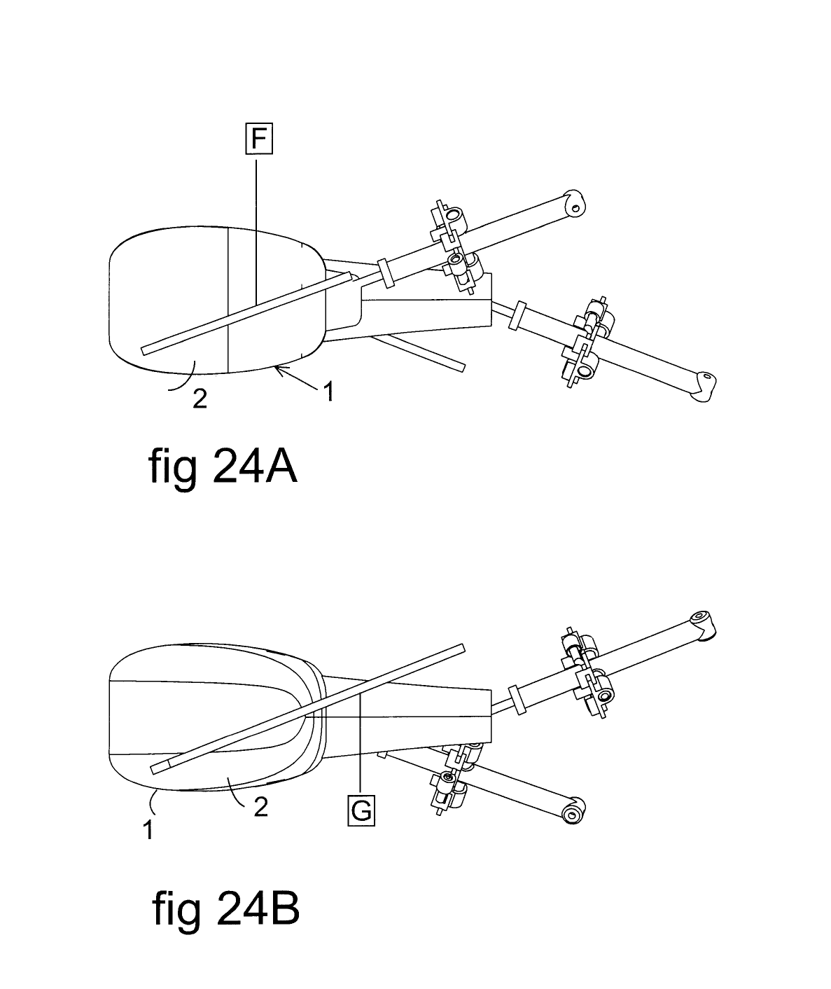

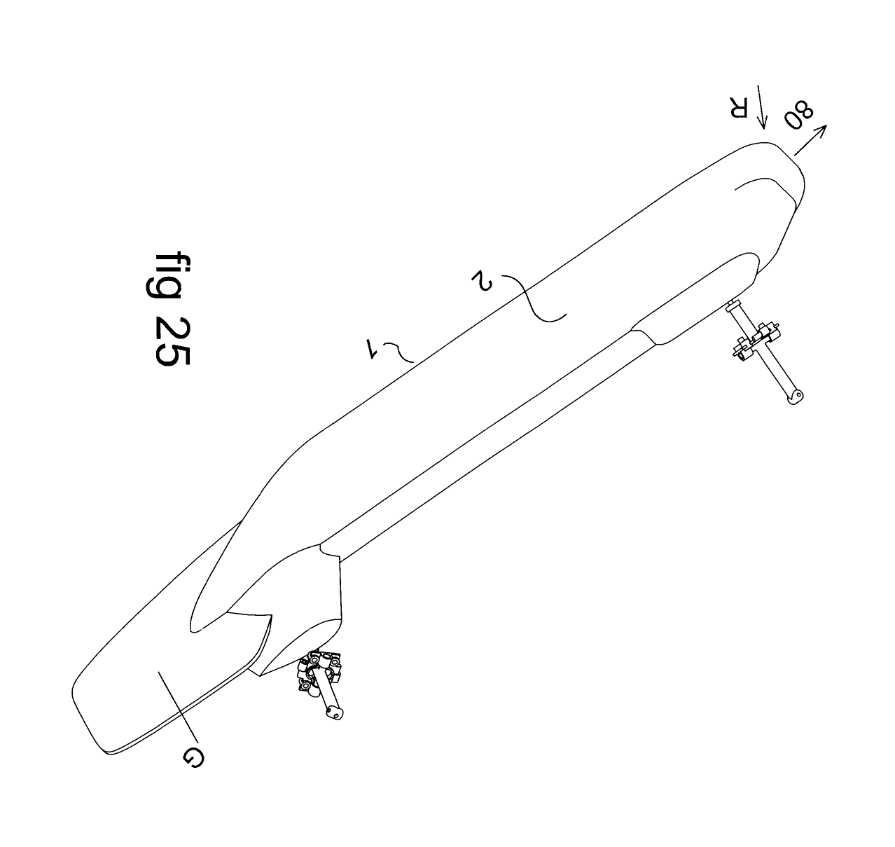

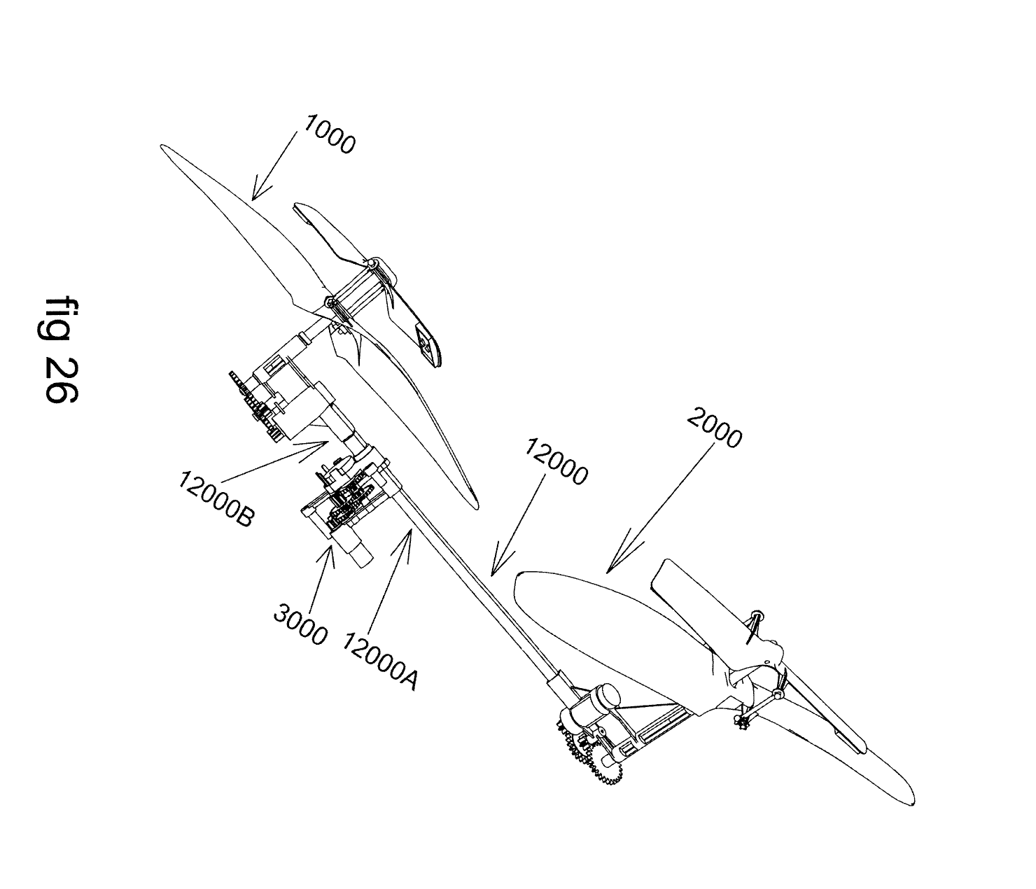

The surfaces of fins F and G can be inclined to be more or less in line with the airflow of the incline rotorshafts the embodiment of the rotors rotating in the same direction. This intensifies the effect and reduces airflow friction over those surfaces, as shown in FIGS. 24A and 24B.

The effect of increased yaw stability is also accomplished in the case of having one of the surface of fins F or G. Alternatively, the ratio between the surface of fins F and G can be significantly different from 1 to 1. In that case, the effect is still there. It may be somewhat reduced because the effects of both rotors are not used to a full extent.

In some cases where the ratio between F and G is largely different from 1 to 1, and due to the arrow effect briefly described above, the helicopter only feels comfortable moving (due to an eventual forward command given by the pilot) in the direction 80 opposite the main lateral surface of the body. This is shown in FIG. 25.

One of the surfaces of fins F and G can be added or removed depending on the main direction of movement. In usual flight, helicopters will hover or fly forward, so only surface G may be needed. This is shown in FIG. 25.

The fin extensions F and/or G can reach essentially the outer circumferential point reached by the rotating rotor. Even if they do not reach to the other circumferential point, there will be a stabilizing effect.

FIG. 26 represents a system for controlling yaw. The yaw of a tandem helicopter as illustrated in FIG. 26 with rotors turning in the same direction can be controlled by changing the incidence of one rotor shaft of rotor 1000 versus the other rotor shaft of the tandem rotor 2000. This change in inclination changes the size of the horizontal components of the lift forces. This varies the size of the torque, which in turn varies the turning direction of the body. One method of varying this incidence is represented in FIG. 26. The two rotor shafts of the two rotors 1000 and 2000 are attached to a central boom 12000. This central boom 12000 is split in two parts 12000A and 12000B. 12000A and 12000B can rotate against each other driven by a servo mechanism. This mechanism can be a motor based system 3000, or use other actuators like piezo actuators, polymer actuators, magnet/coil assemblies and comparable technologies.

The present disclosure is not limited to the embodiments described as an example and represented in the accompanying figures. Many different variations in size and scope and features are possible. For instance, instead of electrical motors being provided others forms of motorized power are possible. A different number of blades may be provided to the rotors.

A helicopter according to the disclosure can be made in all sorts of shapes and dimensions while still remaining within the scope of the disclosure. In this sense although the helicopter in some senses has been described as toy or model helicopter, the features described and illustrated can have use in part or whole in a full-scale helicopter.

While the apparatus and method have been described in terms of what are presently considered to be the most practical and preferred embodiments, it is to be understood that the disclosure need not be limited to the disclosed embodiments. In some cases there may be more than two propellers and/or vanes on one or more of the respective main rotors or tandem rotors and their respective auxiliary rotors. Also the acute angle between the propeller and vane can vary in extent and can be less than 10° and more than 17°.

Although the invention has been described in detail with regard to a tandem helicopter, it is clear that the rotors can cause other objects to fly in a similar stabilized manner. The body of those objects can take different forms, for instance different toy vehicles or toy figurines. These could be robots, insects, motorcars, flying saucers, airplanes, or any other body type that one may want to fly above the ground, floor or base.

It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A helicopter comprising a body; a main rotor with propeller blades driven by a rotor shaft on which the blades are mounted; a tandem rotor with propeller blades driven by a second rotor shaft directed substantially parallel to the rotor shaft of the main rotor, an auxiliary rotor driven by the rotor shaft of the main rotor and provided with vanes from the rotor shaft for rotation in the sense of rotation of the main rotor, the auxiliary rotor being mounted in a swinging relationship on an oscillatory shaft and the swinging motion being relatively upwardly and downwardly about the auxiliary shaft, and which auxiliary shaft is provided essentially transverse to the rotor shaft of the main rotor, the main rotor and the auxiliary rotor being connected to each other by a mechanical link, such that the swinging motion of the auxiliary rotor controls the angle of incidence of at least one of the propeller blades of the main rotor.

2. A helicopter according to claim 1 including an auxiliary rotor driven by the rotor shaft of the tandem rotor and provided with vanes from the rotor shaft for rotation in the sense of rotation of the tandem rotor, the auxiliary rotor being mounted in a swinging relationship on an oscillatory shaft and the swinging motion being relatively upwardly and downwardly about the auxiliary shaft, and which auxiliary shaft is provided essentially transverse to the rotor shaft of the tandem rotor, the tandem rotor and the auxiliary rotor being connected to each other by a mechanical link, such that the swinging motion of the auxiliary rotor controls the angle of incidence of at least one of the propeller blades of the tandem rotor.

3. A helicopter according to claim 1 wherein the main rotor and tandem rotor each includes two propeller blades situated essentially in line with each other.

4. A helicopter according to claim 1 wherein the propeller blades of the main rotor, and the vanes of the auxiliary rotor are connected to the main rotor with a mechanical linkage that permits the relative movement between the blades of the main propeller and the vanes of the auxiliary rotor, and a joint of the main rotor to the propeller blades is formed of a spindle which is fixed to the rotor shaft of the main rotor.

5. A helicopter according to claim 4 wherein the propeller blades of the tandem rotor, and the vanes of the auxiliary rotor for the tandem rotor are connected to the tandem rotor with a mechanical linkage that permits the relative movement between the blades of the tandem propeller and the vanes of the auxiliary rotor, and a joint of the tandem rotor to the propeller blades is formed of a spindle which is fixed to the rotor shaft of the tandem rotor.

6. A helicopter according to claim 4 wherein the spindle of the main rotor extends essentially in the longitudinal direction of the propeller blade of the main rotor which is parallel to one of the vanes or is located at an acute angle relative to the longitudinal direction.

7. A helicopter according to claim 1 wherein the mechanical link includes a rod hinge mounted to a vane of the auxiliary rotor with one fastening point and is hinge-mounted with another fastening point to the propeller blade of the main rotor.

8. A helicopter according to claim 5 wherein the fastening point of the rod is situated on the main rotor at a distance from the axis of the spindle of the propeller blades of the main rotor, and the other fastening point of the rod is situated on the auxiliary rotor at a distance from the axis of the oscillatory shaft of the auxiliary rotor.

9. A helicopter according to claim 8 wherein the distance between the fastening point of the rod on the main rotor and the axis of the spindle of the propeller blades of the main rotor is larger than the distance between the fastening point of the rod on the auxiliary rotor and the axis of the oscillatory shaft of the auxiliary rotor.

10. A helicopter according to claim 8 or 9 wherein the distance between the fastening point of the rod on the main rotor and the axis of the spindle of the propeller blades of the main rotor is about the double the distance between the other fastening point on the auxiliary rotor and the axis of the oscillatory shaft of the auxiliary rotor.

11. A helicopter according to claim 7 wherein the rod is fixed to lever arms with its fastening point respectively part of the main rotor and of the auxiliary rotor.

12. A helicopter according to claim 1 wherein the longitudinal axis of the vanes of the auxiliary rotor is located within an angle of about 10 to about 17 degrees with the longitudinal axis of one of the propeller blades of the main rotor.

13. A helicopter according to claim 1 wherein the longitudinal axis of one of the propeller blades of the main rotor is located at an acute angle with the axis of a spindle mounting these propeller blades to the rotor shaft.

14. A helicopter according to claim 1 wherein the diameter of the auxiliary rotor is smaller than the diameter of the main rotor.

15. A helicopter according to claim 1 wherein the main rotor and the tandem rotor rotate in the same direction.

16. A helicopter according to claim 2 wherein the main rotor and the tandem rotor rotate in the same direction.

17. A helicopter according to claim 1 wherein the main rotor and the tandem rotor rotate in the opposite direction.

18. A helicopter according to claim 2 wherein the main rotor and the tandem rotor rotate in the opposite direction.

19. A helicopter comprising a body; a main rotor with propeller blades which is driven by a rotor shaft and which is mounted on this rotor shaft, such that the angle of incidence of the main rotor in the plane of rotation of the rotor and the rotor shaft is variable, and an auxiliary rotor rotatable with the rotor shaft and being for relative oscillating movement about the rotor shaft and being such that different relative position so that the auxiliary rotor causes the angle of incidence the main rotor to be different, and a tandem rotor with propeller blades driven by a second rotor shaft directed substantially parallel to the rotor shaft of the main rotor.

20. A helicopter according to claim 19 wherein the main rotor and the tandem rotor rotate in the same direction.

21. A helicopter according to claim 1 wherein the body includes at least one extension longitudinally from the helicopter body along a longitudinal axis of the helicopter body.

22. A helicopter according to claim 21 wherein there is an extension directed forwardly of the front of the body and an extension directed rearwardly of the rear of the body.

23. A helicopter comprising a body, a main rotor with propeller blades which is driven by a rotor shaft and which is mounted on this rotor shaft, such that the angle between the plane of rotation of the main rotor and the rotor shaft may vary; an auxiliary rotor with the main rotor and provided with two vanes, the motion of the auxiliary rotor controlling the angle of incidence of at least one of the propeller blades of the main rotor, and a tandem rotor driven by a second rotor shaft directed substantially parallel to the rotor shaft of the main rotor; and an auxiliary rotor with the tandem rotor and provided with two vanes.

24. A helicopter according to claim 23 wherein the auxiliary rotors of the respective main and tandem rotors are driven by the respective rotor shafts, the respective auxiliary rotors being mounted in a swinging relationship on an oscillatory shaft and the swinging motion being relatively upwardly and downwardly about the auxiliary shaft, and which auxiliary shaft is provided essentially transverse to the respective rotor shaft of the rotors, the main rotors and the related auxiliary rotors being connected to each other by a mechanical link, such that the swinging motion of the auxiliary rotors controls the angle of incidence of at least one of the propeller blades of the respective main rotor.

25. A helicopter comprising a body; a main rotor with propeller blades driven by a rotor shaft on which the blades are mounted; a tandem rotor driven by a second rotor shaft directed substantially parallel to the rotor shaft of the main rotor, an auxiliary rotor driven by the rotor shaft of the main rotor and provided with vanes from the rotor shaft for rotation, the auxiliary rotor being mounted such that the longitudinal axis of one of the propeller blades of the main rotor is located at an acute angle relative to the longitudinal axis of one of the vanes of the auxiliary rotor.

26. A helicopter according to claim 23 wherein the main rotor includes two propeller blades situated essentially in line with each other.

27. A helicopter according to claim 23 wherein the propeller blades of the main rotor, and the vanes of the auxiliary rotor respectively are connected to each other with a mechanical linkage that permits the relative movement between the blades of the propeller and the vanes of the auxiliary rotor, and a joint of the main rotor to the propeller blades is formed of a spindle which is fixed to the rotor shaft of the main rotor.

28. A helicopter according to claim 23 wherein the longitudinal axis of the vanes of the auxiliary rotor is located at about an angle of about 10 degrees to about 17 degrees with the longitudinal axis of one of the propeller blades of the main rotor.

29. A helicopter according to claim 23 wherein the diameter of the vanes of auxiliary rotors of each of respective main and tandem rotors are smaller than the diameter of the propellers of the main and tandem rotors.

30. A helicopter comprising a body; a main rotor with propeller blades driven by a rotor shaft on which the blades are mounted; a tandem rotor driven by a second rotor shaft directed substantially parallel to the rotor shaft of the main rotor with propeller blades driven by the second rotor shaft on which the blades are mounted, an auxiliary rotor driven by the rotor shaft of the main rotor and provided with vanes from the rotor shaft for rotation in the sense of rotation of the main rotor, the auxiliary rotor being mounted such that the longitudinal axis of one of the propeller blades of the main rotor is located relative to the longitudinal axis of one of the vanes of the auxiliary rotor, and the main rotor and the auxiliary rotor being connected to each other by a mechanical link, such that a swinging motion of the auxiliary rotor controls the angle of incidence of at least one of the propeller blades of the main rotor, and an auxiliary rotor driven by the rotor shaft of the tandem main rotor and provided with vanes from the rotor shaft of the tandem rotor for rotation in the sense of rotation of the main rotor of the tandem, the auxiliary rotor of the tandem router being mounted such that the longitudinal axis of one of the propeller blades of the main rotor is located relative to the longitudinal axis of one of the vanes of the auxiliary rotor, and the main rotor and the auxiliary rotor being connected to each other by a mechanical link, such that a swinging motion of the auxiliary rotor controls the angle of incidence of at least one of the propeller blades of the main rotor.

31. A helicopter according to claim 30 wherein the diameter of the auxiliary rotor is smaller than the diameter of the main rotor of each of the main rotor and tandem rotor.

32. A helicopter according to claim 30 wherein the auxiliary rotor is provided with stabilizing weights which are fixed respectively to a vane.

33. A helicopter comprising a body; a main rotor with propeller blades driven by a rotor shaft on which the blades are mounted; a tandem rotor driven by a second rotor shaft directed substantially parallel to the rotor shaft of the main rotor, an auxiliary rotor driven by the rotor shaft of the main rotor and provided with vanes from the rotor shaft for rotation in the general sense of rotation of the main rotor, the auxiliary rotor being mounted such that the longitudinal axis of one of the propeller blades of the main rotor is located relative to the longitudinal axis of one of the vanes of the auxiliary rotor; a rotor with propeller blades which is driven by a rotor shaft and which is mounted on this rotor shaft, such that the angle of incidence of the rotor in the plane of rotation of the rotor and the rotor shaft is variable; and an auxiliary rotor rotatable with the rotor shaft and being for relative oscillating movement about the rotor shaft and being such that different relative position so that the auxiliary rotor causes the angle of incidence the main rotor to be different.

34. A helicopter comprising a body; a main rotor with propeller blades driven by a rotor shaft on which the blades are mounted; a tandem rotor driven by a second rotor shaft directed substantially parallel to the rotor shaft of the main rotor, for the main rotor there being an auxiliary rotor driven by the rotor shaft of the main rotor and provided with vanes from the rotor shaft for rotation in the general sense of rotation of the main rotor, the auxiliary rotor being mounted such that the longitudinal axis of one of the propeller blades of the main rotor is located relative to the longitudinal axis of one of the vanes of the auxiliary rotor; such that the angle between the plane of rotation of the main rotor and the rotor shaft is variable; for the tandem rotor there being an auxiliary rotor driven by the rotor shaft of the rotor of the tandem rotor, and the auxiliary rotor having two vanes extending essentially in a longitudinal axis essentially generally about parallel to the longitudinal axis of at least one of the propeller blades of the main rotor or at a relatively small acute angle relative to the longitudinal axis of the propeller of the tandem rotor, each of the auxiliary rotors being mounted respectively in a swinging relationship on an oscillatory shaft which is provided essentially transversally to its rotor shaft of the respective main rotor and tandem rotors and the swinging motion of the auxiliary rotor controlling the angle of incidence of at least one of the propeller blades of the respective main rotor.

35. A helicopter according to claim 34, wherein the main rotor includes two propeller blades situated essentially in line with each other.

36. A helicopter according to claim 34 wherein the longitudinal axis of one of the propeller blades of the main rotor is located at an acute angle with the longitudinal axis of the of the respective vanes.

37. A helicopter according to claim 34 wherein the main rotor and the tandem rotor rotate in the same direction.

38. A helicopter according to claim 30 wherein the main rotor and the tandem rotor rotate in the opposite direction.

39. A helicopter as claimed in claim 1 wherein the body includes a front end and considered transversely the extent of the body at the front end is substantially at the same position as the outer circumferential position of the main rotor.

40. A helicopter as claimed in claim 1 wherein the body includes a rear end and considered transversely the extent of the body at the rear end is substantially the same position as the outer circumferential position of the tandem rotor.

41. A helicopter as claimed in claim 1 wherein at least one of the rotor shaft for the main rotor or the rotor shaft for the tandem rotor is relatively inclined in relation to a vertical axis through the body.

42. A helicopter as claimed in claim 41 wherein both of the shafts are relatively inclined to the vertical axis.

43. A helicopter as claimed in claim 42 wherein the inclination of the main rotor shaft and the tandem rotor shaft are oppositely inclined relative to the vertical axis.

44. A helicopter as claimed in claim 1 wherein the inclination relative to the vertical axis is controlled by a servo mechanism, the mechanism being responsive thereby to control yaw.

45. A helicopter as claimed in claim 42 wherein the inclination relative to the vertical axis is controlled by a servo mechanism, the mechanism being responsive thereby to control yaw.

46. A helicopter as claimed in claim 43 wherein the inclination relative to the vertical axis is controlled by a servo mechanism, the mechanism being responsive thereby to control yaw.

47. A flying object comprising a body; a main rotor with propeller blades driven by a rotor shaft on which the blades are mounted; a tandem rotor with propeller blades driven by a second rotor shaft directed substantially parallel to the rotor shaft of the main rotor, an auxiliary rotor driven by the rotor shaft of the main rotor and provided with vanes from the rotor shaft for rotation in the sense of rotation of the main rotor, the auxiliary rotor being mounted in a swinging relationship on an oscillatory shaft and the swinging motion being relatively upwardly and downwardly about the auxiliary shaft, and which auxiliary shaft is provided essentially transverse to the rotor shaft of the main rotor, the main rotor and the auxiliary rotor being connected to each other by a mechanical link, such that the swinging motion of the auxiliary rotor controls the angle of incidence of at least one of the propeller blades of the main rotor.

48. The flying object as claimed in claim 47, wherein the body of the object is selectively a toy vehicle or toy figurine.

49. A flying object comprising a body; a main rotor with propeller blades which is driven by a rotor shaft and which is mounted on this rotor shaft, such that the angle of incidence of the main rotor in the plane of rotation of the rotor and the rotor shaft is variable, and an auxiliary rotor rotatable with the rotor shaft and being for relative oscillating movement about the rotor shaft and being such that different relative position so that the auxiliary rotor causes the angle of incidence the main rotor to be different, and a tandem rotor with propeller blades driven by a second rotor shaft directed substantially parallel to the rotor shaft of the main rotor.

50. The flying object as claimed in claim 49, wherein the body of the object is selectively a toy vehicle or toy figurine.
